(19) United States
(12) Patent Application Publication
(10) Pub. No.: US 2025/0388761 A1
(43) Pub. Date: Dec. 25, 2025

(54) HYBRID ORGANIC-INORGANIC TWO-DIMENSIONAL METAL CARBIDE MXENES

(71) Applicant: THE UNIVERSITY OF CHICAGO, Chicago, IL (US)

(72) Inventors: Chenkun Zhou, Chicago, IL (US); Dmitri V. Talapin, La Grange Park, IL (US)

(21) Appl. No.: 18/880,400

(22) PCT Filed: Aug. 18, 2023
(86) PCT No.: PCT/US23/72491

§ 371 Date: Dec. 31, 2024

Related U.S. Application Data
(60) Provisional application No. 63/399,958, filed on Aug. 22, 2022.

(51) Int. Cl. C09C 3/08; C09C 1/36

(52) U.S. Cl. CPC C09C 3/08; C09C 1/36; C01P 2002/72; C01P 2002/77; C01P 2002/82; C01P 2002/86; C01P 2002/88; C01P 2004/03; C01P 2004/04

(57) ABSTRACT

Hybrid organic-inorganic MXenes (h-MXenes) having amido, imido, alkoxy, or aryloxy surface terminating groups and methods for synthesizing the hybrid organic-inorganic MXenes are provided. The synthesis of h-MXenes having a broad scope of erminal organic functional groups is carried out via the displacement of halide atoms from halide-terminated MXenes by deprotonated primary organic amines or deprotonated alcohols.

### CROSS-REFERENCE TO RELATED APPLICATIONS

The present application claims priority to U.S. provisional patent application No. 63/399,958 that was filed Aug. 22, 2022, the entire contents of which are incorporated herein by reference.

### REFERENCE TO GOVERNMENT RIGHTS

This invention was made with government support under grant number FA9550-18-1-0099 awarded by the Air Force Office of Scientific Research, grant numbers DMR2011854, DMR1831406, DMR0959470, and DMR1626065 awarded by the National Science Foundation, and grant numbers DE-AC02-06CH11357 and DE-AC02-07CH11358 awarded by the Department of Energy. The government has certain rights in the invention.

### BACKGROUND

Two-dimensional (2D) transition-metal carbides and nitrides (MXenes) show impressive performance in applications, such as supercapacitors, batteries, electromagnetic interference shielding, or electrocatalysis. These materials combine the electronic and mechanical properties of 2D inorganic crystals with chemically modifiable surfaces.

MXenes are typically prepared from MAX phases, where M represents an early transition metal (e.g., Ti, Nb, V, Mo, etc.), A represents elements mainly from groups 13-16 (Al, Si, etc.), and X stands for C or N. MAX phases are converted to 2D MXenes by selectively etching away A-layer elements, typically using fluoride solutions. The resulting exfoliated MXenes have a mixture of —F, —O, and —OH surface termination groups usually denoted as Tₓ. Unlike surfaces of graphene and transition-metal dichalcogenides, the basal surfaces of MXenes allow for further chemical modification with different functional groups. However, the very strong Ti—F and Ti—O bonds introduced during MAX exfoliation with fluoride reagents make post-synthetic substitutions of Tₓ surface groups difficult. New synthetic routes, which omit fluoride by transferring the MAX etching process to a molten-salt medium, can produce MXenes with pure Cl or Br terminations. Ti—Cl and Ti—Br surface bonds are labile enough to allow the exchange of surface halogen atoms with other groups, and MXenes with oxo- (Ti₃C₂O), imido- (Ti₃C₂NH), thio- (Ti₃C₂S), seleno- (Ti₃C₂Se), or telluro- (Ti₃C₂Te) terminations, as well as bare MXenes (Ti₃C₂□2), can all be prepared from Ti₃C₂Cl₂ or Ti₃C₂Br₂. The surface groups can define MXene properties, such as superconductivity and electrochemical energy storage capacitance. Theoretical studies have predicted that surface terminations control many other physical and chemical properties of MXenes.

### SUMMARY

Hybrid organic-inorganic MXenes (h-MXenes) with various organic functional groups covalently bound to inorganic two-dimensional sheets via amido and/or imido groups are provided. Method for making the h-MXenes are also provided.

Some embodiments of the h-MXenes have the formula M₍ₙ₊₁₎Xₙ(NR)ₓ(NHR)_{y}, where 1≤n≤4, M is an early transition metal atom, X is carbon or nitrogen, NR represents surface-terminating amido groups, and NHR represents surface-terminating imido groups, where R is an organic functional group, at least one of x and y is greater than zero, and (x+y)≤1.

Some embodiments of the h-MXenes have the formula M₍ₙ₊₁₎Xₙ(OR′)_{z}, where 1≤n≤4, M is an early transition metal atom, X is carbon or nitrogen, OR′ represents surface-terminating alkoxy or aryloxy groups, and 0<z≤1.

Method for the synthesis of the hybrid organic-inorganic two-dimensional transition metal carbide or nitride MXenes include the steps of reacting a primary organic amine or an organic alcohol with a two-dimensional transition metal carbide or nitride MXene having the formula M₍ₙ₊₁₎XₙTₓ, where T represent surface-terminating halogen atoms and 0<x≤2, in the presence of a deprotonating agent, whereby the surface-terminating halogen atoms are displaced by deprotonated primary organic amines or alcohols.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 shows the structure of an h-MXene having a mixture of propylamido and propylimido surface-terminating groups

FIGS. 2A and 2B show a schematic of organic-inorganic h-MXene synthesis (FIG. 2A) and examples of primary amines (FIG. 2B).

FIGS. 3A-3D show structural characterizations of h-MXenes. FIG. 3A shows powder XRD patterns and their Le Bail fits for Ti₃C₂(NH) and h-MXenes with alkylimido surface-termination groups. FIG. 3B shows changes of the lattice c parameter versus number of carbons in the interlayer alkyl groups. FIG. 3C shows a schematic of alkylimido surface termination groups on a Ti₃C₂ sheet. FIG. 3D shows LAADF-STEM images (scale bar: 2 nm) showing the lamellar structures of h-MXenes; the image of Ti₃C₂(dda)_{2/3} was acquired using Cryo-STEM method.

FIGS. 4A-4F show Fano effect in infrared absorption spectra and magic angle spinning (MAS) solid state NMR spectra of h-MXenes. FIG. 4A shows C—H bond stretching region of infrared absorption spectra of Ti₃C₂(hda)_{2/3} showing the Fano resonant coupling compared with the absorption of neat hexadecylamine. FIG. 4B shows a schematic of the Fano coupling between discrete vibrational modes of n-alkylamines and the continuum band of states in metallic Ti₃C₂ sheets. FIG. 4C shows ¹H spin echo, ¹H→¹⁵N CPMAS spin echo, and ¹H-detected ¹⁵N CPMAS spectrum of Ti₃C₂(¹⁵N-dda)_{2/3}. FIG. 4D shows 2D ¹H{¹⁵N} idHETCOR spectra obtained with backwards CP contact times of 0.4 ms or 8 ms to probe short and long-range ¹H-¹⁵N internuclear distances, respectively. FIG. 4E shows ¹H detected ¹⁵N{¹H} heteronuclear spin echo (J-resolved) curves confirming that the ¹⁵N NMR signal at −27 ppm corresponds to an amido nitrogen (NHR), while the ¹⁵N NMR signal at 30 ppm corresponds to a deprotonated imido nitrogen (NR). All spectra were obtained with an MAS frequency of 50 kHz. FIG. 4F shows the bonding motifs between the organic and inorganic components of h-MXenes.

FIGS. 5A-5F show delamination, colloidal dispersion, and hydrolytic stability of h-MXenes and schematics of delaminated h-MXenes with different types of surface ligands. FIG. 5A shows d-Ti₃C₂(oca)_{2/3}. FIG. 5B shows d-Ti₃C₂(oca/ola)_{2/3}. FIG. 5C shows d-Ti₃C₂(pra/PEG₁ₖ)_{2/3}. FIG. 5D shows powder XRD patterns and FIG. 5E shows Raman spectra of Ti₃C₂Tₓ, Ti₃C₂(NH), and Ti₃C₂(oca)_{2/3} after exposure to 71° C. pure water for 7 days and 13 days. FIG. 5F shows SEM images of original Ti₃C₂(oca)_{2/3} and after exposure to 71° C. pure water for 13 days.

FIGS. 6A-6D show a surface exchange reaction of Ti₃C₂ MXenes with amines and thermal degradation analysis of h-MXenes. FIG. 6A shows X-ray fluorescence (XRF) spectral and elemental analysis for the Ti₃C₂Br₂ and Ti₃C₂(bua)_{2/3} MXenes. FIG. 6B shows Powder XRD patterns of products after treatment of Ti₃C₂Br₂ with butylamine and NaH at 120° C. for 2 days, as well as the products of control experiments. FIG. 6C shows powder XRD patterns of Ti₃C₂Br₂ before and after treatment with triethylamine and NaH at 120° C. for 2 days. FIG. 6D shows TGA characterization of Ti₃C₂(pra)_{2/3} MXene.

FIGS. 7A-7D show a surface exchange reaction of Ti₃C₂ MXenes with amines and thermal degradation analysis of h-MXenes. FIG. 7A shows powder XRD patterns of Ti₃C₂(bua)_{2/3} prepared by using different halogen terminated MXenes and deprotonating agents. FIG. 7B shows powder XRD patterns from diamine-modified h-MXenes and their Le Bail fits. FIG. 7C shows powder XRD patterns from aromatic amine- and 2-methoxyethylamine-modified h-MXenes and their Le Bail fits. FIG. 7D shows powder XRD patterns from different types of Cl-terminated MXenes treated with butylamine and n-BuLi.

FIGS. 8A-8C show tilt angle of the alkyl chains of the surface termination groups relative to the surface normal. FIG. 8A shows a summary of the metal to surface group elemental ratios for Ti₃C₂(NH), alkylamine- and diamine-modified h-MXenes. FIG. 8B shows change of c lattice parameters versus number of CH₂ groups in the alkylamine molecules. FIG. 8C shows a schematic of Ti₃C₂ sheets sandwiched by two layers of alkylimido surface termination groups.

FIG. 9A shows ¹H{¹⁵N} variable back contact time cross-polarization (CP) experiment used to measure ¹H-¹⁵N dipolar coupling constants and H—N internuclear distances. FIG. 9B shows NMR signal for the ¹H signal at 20 ppm as a function of the back-CP contact time. The signal has also been vertically offset to allow for Fourier transformation. FIG. 9C shows Fourier transformation of the offset contact time curve reveals a splitting of 7.5 kHz, which corresponds to a heteronuclear dipolar coupling constant of 10.7 kHz after multiplication by a scaling factor of 1.43. A 10.7 kHz dipolar coupling constant corresponds to an N—H bond length of 1.04 Å. FIG. 9D shows NMR signal for the ¹H signal at 9 ppm as a function of the back-CP contact time (black points). This curve was fit to a ¹H-¹⁵N coupling constant of 1.9 kHz which corresponds to an approximate ¹H-¹⁵N internuclear distance of 1.9 Å. FIG. 9E shows root mean squared error between the different simulated and experimental contact time curves for different dipolar coupling constants.

FIG. 10 shows a powder XRD pattern for Ti₃C₂(buo)_{2/3} formed by the reaction of Ti₃C₂Br₂, butanol (buo), and n-BuLi at 120° C. for 80 hours.

### DETAILED DESCRIPTION

Hybrid organic-inorganic MXenes (h-MXenes) having amido and/or imido surface terminating groups or alkoxy and/or aryloxy surface terminating groups and methods for synthesizing the h-MXenes are provided. The h-MXenes, which are made by reacting halogen-terminated MXenes with deprotonated organic amines or deprotonated alcohols unite the tailorability of organic molecules with electronic connectivity and other properties characteristic of inorganic 2D materials. The amido/imido and/or alkoxy/aryloxy surface chemistry of the h-MXenes provides them with thermal stability and resistance to hydrolysis and facilitates charge, heat, and/or energy transfer across the organic-inorganic interface. As a result, the MXenes are useful in a wide range of applications and devices, including supercapacitors, batteries, and electromagnetic interference (EMI) shielding.

h-MXene Structure.

The amido- and/or imido-terminated h-MXenes can be represented by the chemical formula: M₍ₙ₊₁₎Xₙ(NR)ₓ(NHR)_{y}, where 1≤n≤4, M is an early transition metal atom. X is carbon or nitrogen, and layers of the early transition metal, M, are interleaved by layers of the carbon or nitrogen, X. In the formula, NR and NHR represent surface-terminating amido groups and surface-terminating imido groups, respectively, where R is an organic functional group, at least one of x and y is greater than zero, and (x+y)≤1. The R groups of an h-MXene may all be the same or may include a combination of two or more different R groups. The organic functional groups (R) are organic groups that include carbon and hydrogen atoms. The organic functional groups may also include oxygen, nitrogen and/or sulfur atoms, as well as other atoms.

Alkyl groups, alkynl groups, alkynyl groups, alkylaryl groups, alkylamine groups, and ether groups are examples of organic functional groups. The alkyl groups, alkenyl groups, and alkynyl groups may be linear, branched, or cyclic aliphatic hydrocarbons. In some embodiments of the h-MXenes, the alkyl groups are C1 to C16 hydrocarbons, including C3 to C12 hydrocarbons. Examples of alkyl groups include propyl groups, butyl groups, octyl groups, dodecyl groups, and hexadecyl groups. The alkylaryl groups include an alkyl group bonded to an aryl group, wherein the aryl group may have a single aromatic ring or two or more connected or fused aromatic rings. The aryl groups may be heteroaryl groups in which an aromatic ring includes one or more non-carbon atoms, such as a nitrogen, oxygen, sulfur, or phosphorus atom. In some embodiments of the alkylaryl groups, the alkyl group is a methyl group (—CH₂) connecting an aryl group to the amido or imido nitrogen atom. Examples of alkylaryl groups include benzyl groups, methylbenzyl groups, and thiophenylmethyl groups. The alkylamines include an alkyl group bonded to an amine group. Examples of alkylamine groups include aminoethyl groups, aminopropyl groups, and N-methylethylamine groups. The ether groups include an alkyl group bonded to an oxygen. The ether groups include polyether groups in which two or more ether groups are bonded in a chain and ether groups that terminate in an alkyl group. Examples of ether groups include 2-methoxyethyl groups, 2-(2-methoxyethoxy)ethyl groups, and poly(ethylene glycol) groups.

The alkoxy- and aryloxy-terminated h-MXenes can be represented by the chemical formula: M₍ₙ₊₁₎Xₙ(OR)ₓ, where 1≤n≤4, M is an early transition metal atom, X is carbon or nitrogen, and layers of the early transition metal, M, are interleaved by layers of the carbon or nitrogen, X. In the formula, OR represents surface-terminating alkoxy and/or aryloxy groups, where R is an alkyl group, an alkylarylalkyl group, an alkylalcohol group, or a combination thereof (alkyl and aryl are as described above), and 0<x≤2.

In some embodiments of the alkoxy-terminated h-MXenes, the alkyl groups of the alkoxy terminations are C1 to C16 hydrocarbons, including C3 to C12 hydrocarbons. Examples of alkoxy groups include propoxy groups, butoxy groups, hexoxy group, octoxy group, and hexadecoxy group. In some embodiments of the alkylaryloxy-terminated h-MXenes, the alkylaryl groups include an alkyl group bonded to an aryl group, wherein the aryl group may have a single aromatic ring or two or more connected or fused aromatic rings. The aryl groups may be heteroaryl groups in which an aromatic ring includes one or more non-carbon atoms, such as a nitrogen, oxygen, sulfur, or phosphorus atom. In some embodiments of the alkylaryl groups, the alkyl group is a methyl group (—CH₂) connecting an aryl group to the oxygen atom. Examples of alkylaryl groups include benzyl groups, methylbenzyl groups, and thiophenylmethyl groups. The alkylalcohol groups include an alkyl group bonded to a hydroxyl group. Examples of alkylalcohol groups include hydroxyethyl groups, hydroxypropyl groups, and hydroxybutyl groups.

The early transition metals are 3d-5d block transition metals (Groups 3-7 of the periodic table), including titanium (Ti), zirconium (Zr), hafnium (Hf), vanadium (V), niobium (Nb), tantalum (Ta), chromium (Cr), molybdenum (Mo), tungsten (W), scandium (Sc), yttrium (Y), or a combination thereof.

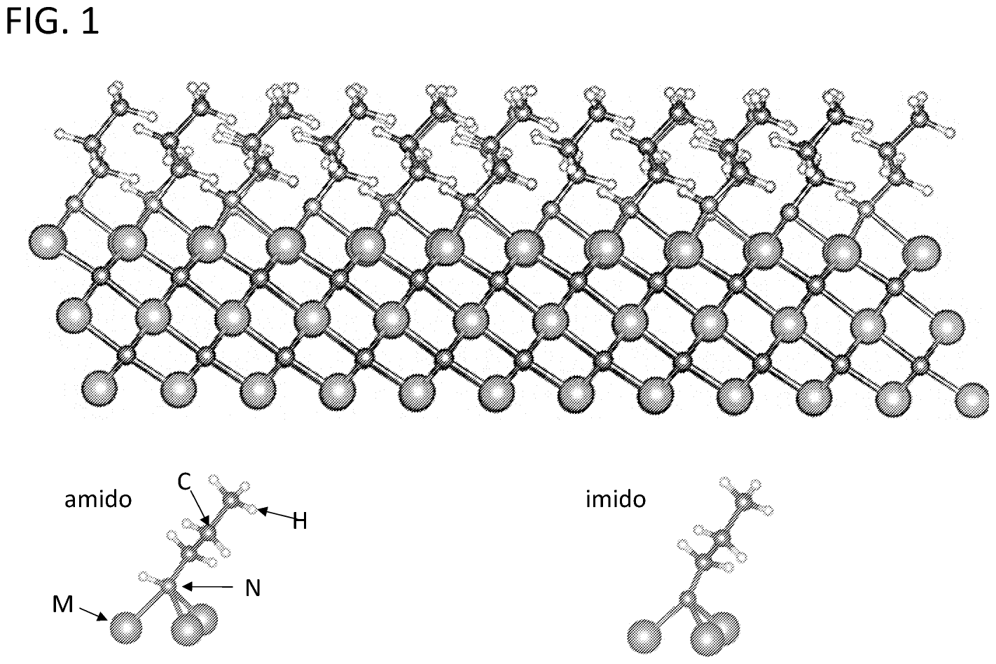

In the h-MXenes, the NR, NHR, and OR terminations are coordinated to the surface M atoms of an M₃X₂ sheet, such that layers of the organic functional groups (R) are sandwiched between neighboring M₃X₂ sheets. For purposes of illustration, FIG. 1 shows the structure of an h-MXene having a mixture of amido and imido surface-terminating groups, where the organic functionalities (the R groups) are propyl groups. The lower panels in the figure show individual surface-terminating amido and imido groups bound to surface M atoms. As shown in FIG. 1, alkyl groups may assume a self-assembled monolayer (SAM)-like configuration in which the alkyl chains are tilted from the surface normal between the M₃X₂ sheets.

The size (e.g., alkyl chain lengths) of the organic functionalities of the surface-terminating amido, imido, alkoxy, and aryloxy groups can be selected to achieve a desired spacing between Ti₃C₂ sheets, where larger (e.g., longer) organic groups generally increase the intersheet spacing. Moreover, the organic functionalities of the surface-terminating groups can be selected to facilitate the delamination and dispersion of the individual sheets of the h-MXenes in non-polar solvents or in aqueous solution, as discussed in more detail below.

The surface-terminating organic groups of the amido, imido, alkoxy, and/or aryloxy terminations may also provide protection against hydrolysis, not only by creating thin hydrophobic barriers, but by rendering the h-MXenes less susceptible to nucleophilic attack by hydroxyl ions.

h-MXene Synthesis.

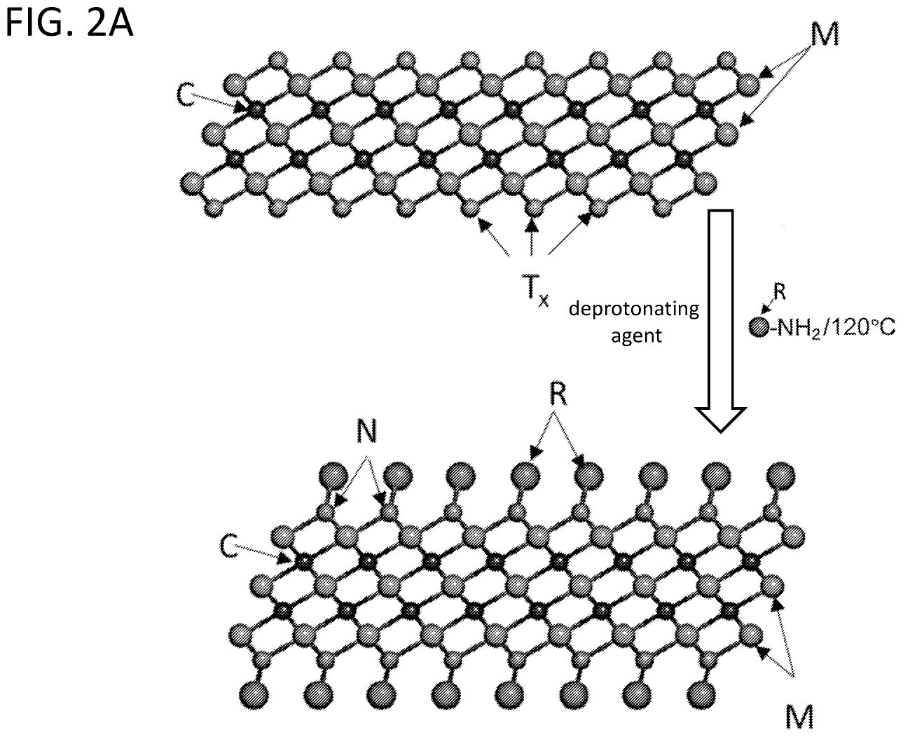

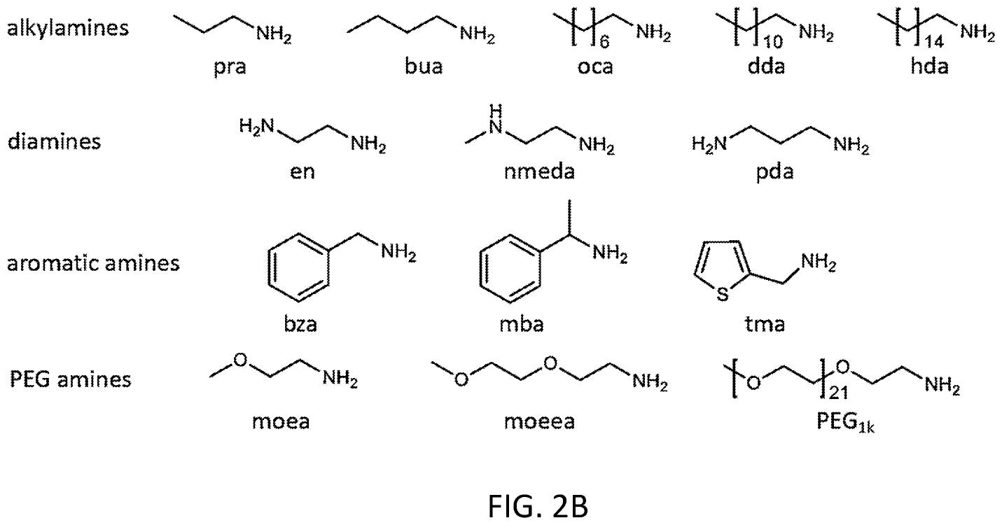

The synthesis of h-MXenes having a broad scope of terminal organic functional groups can be achieved via the displacement of halide atoms from halide-terminated MXenes by deprotonated primary organic amines (e.g., n-alkylamines) or deprotonated alcohols. This reaction is illustrated schematically in FIG. 2A, using a generic primary organic amine as a reactant. In the synthesis, a primary organic amine (or an alcohol) is reacted with a two-dimensional transition metal carbide or nitride MXene having halide surface termination in the presence of a deprotonating agent. The two-dimensional transition metal carbide or nitride MXene having halide surface termination can be represented by the formula M₍ₙ₊₁₎XₙTₓ, where 1≤n≤4, M and X are as previously defined and Tₓ are surface terminating halogen atoms, such as bromine atoms, chloride atoms, iodide atoms, or a combination thereof, and 0<x≤2.

The overall reaction between M₃X₂T₂ MXene, a primary amine, and a deprotonating agent can be represented by the following reaction:

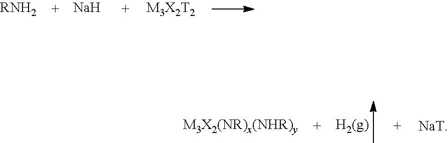

An analogous reaction between M₃X₂T₂ MXene, an alcohol, and a deprotonating agent can be represented as follows:

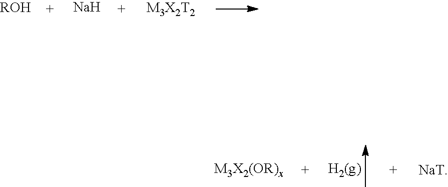

In the reactions above, sodium hydride is used as an illustrative deprotonating agent. However, other deprotonating agents can be used. The deprotonating agents are strong bases with which the primary amine or alcohol undergoes an acid-base reaction, resulting in the deprotonation. Suitable deprotonating agents include NaNH₂, alkyllithium compounds, such as n-butyllithium, and lithium-bis(trimethylsilyl)amide (LiHMDS). Sodium- and lithium-containing deprotonating agents can form a sodium halide or lithium halide in the reaction. The reaction is allowed to proceed for a time and at a temperature sufficient to obtain the h-MXene. The reaction mixture may be heated above room temperature in order to promote the reaction. In some embodiments of the invention, the reaction is carried out at a temperature in the range from about 100° C. to about 150° C. and/or for a time in the range from about 12 hours to about 3 days. However, reaction temperatures and reaction times outside of these ranges may be used.

In the case of the imido-terminated h-MXenes, the halide surface-terminating groups may initially be replaced by the amido surface-terminating groups, some or all of which are then converted into the imido surface-terminating groups. Without intending to be bound to a particular theory behind the reaction, it is proposed that formation of h-MXenes starts with a nucleophilic substitution of the surface halide terminations for RNH⁻, promoted by the formation of solid halide products (e.g., sodium halides or lithium halides). A conversion from an amido- to imido-bonding may then occur at the h-MXene surface. This process can be described as an N—H oxidative addition, leading to the formation of an imido-group and a hydride.

The primary amines that can be used in the synthesis of the amido/imido-terminated h-MXenes include alkylamines, diamines, aromatic amines, and polyalkylene glycol amines, such as polyethylene glycol (PEG)-amines. The deprotonated forms of these primary amines react with the MXenes to form their corresponding h-MXenes. When a diamine is used, one nitrogen atom bonds to the surface of a M₃X₂ sheet while the other remains chemically accessible. Some specific, non-limiting examples of primary amines in each of these categories are propylamine (pra), butylamine (bua), octylamine (oca), dodecylamine (dda), hexadecylamine (hda), ethylenediamine (en) or N-methylethylenediamine (nmeda), propylenediamine (pda), benzylamine (bza), α-methylbenzylamine (mba), 2-thiophenemethylamine (tma), 2-methoxyethylamine (moea), 2-(2-methoxyethoxy)ethanamine (moeea), and polyethylene glycol amine. The chemical structures of these primary amines are shown in FIG. 2B. While the PEG amine shown in FIG. 2B has a polyethylene chain with 21 repeat units, more or fewer repeat units may be present.

Alcohols that can be used in the synthesis of the alkoxy/aryloxy-terminated h-MXenes include 1-propanol (pro), 1-butanol (buo), 1-hexanol (hexo), 1-octanol (octo), and 1-hexadecanol (hdo).

Halide surface-terminated MXenes from which the h-MXenes can be made are known. Methods for synthesizing Br- and Cl-terminated MXenes are described in Example 1. Additional details regarding the synthesis of halide surface-terminated MXenes can be found, for example, in the following references: Kamysbayev, V., et al Science 369, 979-983 (2020); Li, Y., et al. Nat. Mater. 19, 894-899 (2020); Li, M., et al. J. Am. Chem. Soc. 141, 4730-4737 (2019); and Li, M., et al. ACS Nano 15, 1077-1085 (2021).

h-MXene Colloids and Dispersions.

Colloidal solutions of the as-synthesized h-MXenes can be formed by delaminating sheets of the h-MXenes in a solvent. The negative free energy of chain-solvent mixing causes the terminal organic groups on the h-MXenes to repel one another, thus stabilizing colloidal dispersions. The h-MXenes having terminal alkyl groups of different lengths are particularly suited to colloid formation in non-polar solvents because the shorter alkyl chains intermixed with longer alkyl chains provides room for the free rotation of the longer alkyl chains and facilitates the penetration of the solvent between the alkyl and efficient interaction of the organic groups with solvent molecules.

The h-MXenes having terminal organic groups that include polar functionalities, such as amine groups or ether groups, are particularly suited for forming colloids using polar solvents, including aqueous solutions.

### EXAMPLES

### Example 1: Amido- and Imido-Terminated h-MXenes

This example illustrates methods for the synthesis of amido- and/or imido-terminated MXenes, using titanium carbide and niobium carbide MXenes as illustrative examples. However, other amido- and/or imido-terminated MXenes can be synthesized using the guidance provided in this example by starting with halogen surface-terminated MXenes of different early transition metals and/or halogen surface-terminated nitride MXenes.

The h-MXenes were synthesized via the displacement of halides from Br- or Cl-terminated MXenes by deprotonated primary organic amines (e.g., n-alkylamines). The amines were first deprotonated by NaH, n-butyllithium, lithium bis(trimethylsilyl)amide, or sodium amide, and then reacted with multilayer Ti₃C₂Br₂ MXenes at 120° C. for two days. The overall reaction between Ti₃C₂Br₂ and the amine in presence of deprotonating agent NaH is as follows:

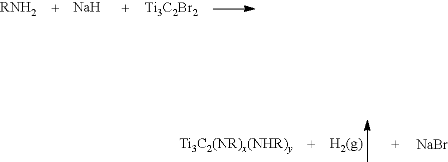

Complete removal of Br was confirmed by X-ray fluorescence (XRF) analysis. Deprotonation of amines is crucial to initiate the exchange reaction on MXene surfaces; tertiary amines (e.g., triethylamine) showed no reactivity toward halide terminated MXenes. Identical products were obtained by reacting Ti₃C₂Br₂ and Ti₃C₂Cl₂ with deprotonated butylamine. Very strong binding of amines to Ti₃C₂ sheets was confirmed by thermogravimetric analysis, which showed that the n-propylamine-functionalized h-MXene Ti₃C₂(pra)_{2/3} had only a 4% weight loss when heated from 50° C. to 400° C.

Besides various alkylamines, this approach was applied use diamines, aromatic amines, and poly(ethylene glycol) (PEG)-amines and the primary amine. The above reaction can also be applied to Ti₂CCl₂ and Nb₂CCl₂ to obtain the corresponding organic-inorganic hybrid Ti₂C or Nb₂C MXenes. The different primary amines used in this Example are shown in FIG. 2B.

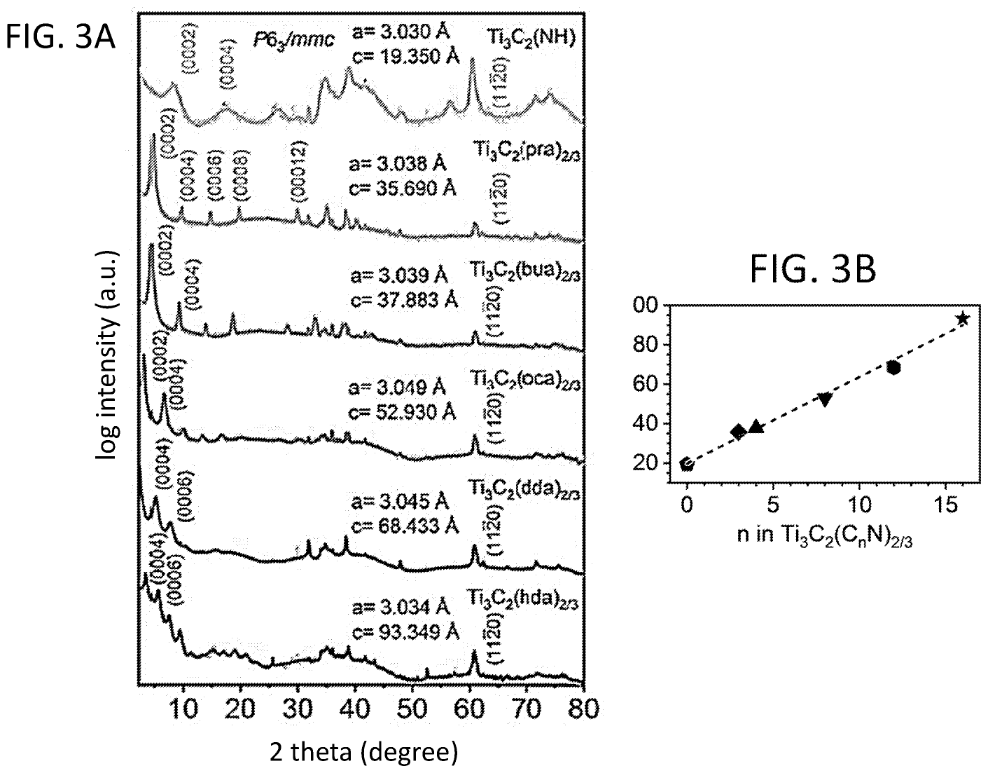

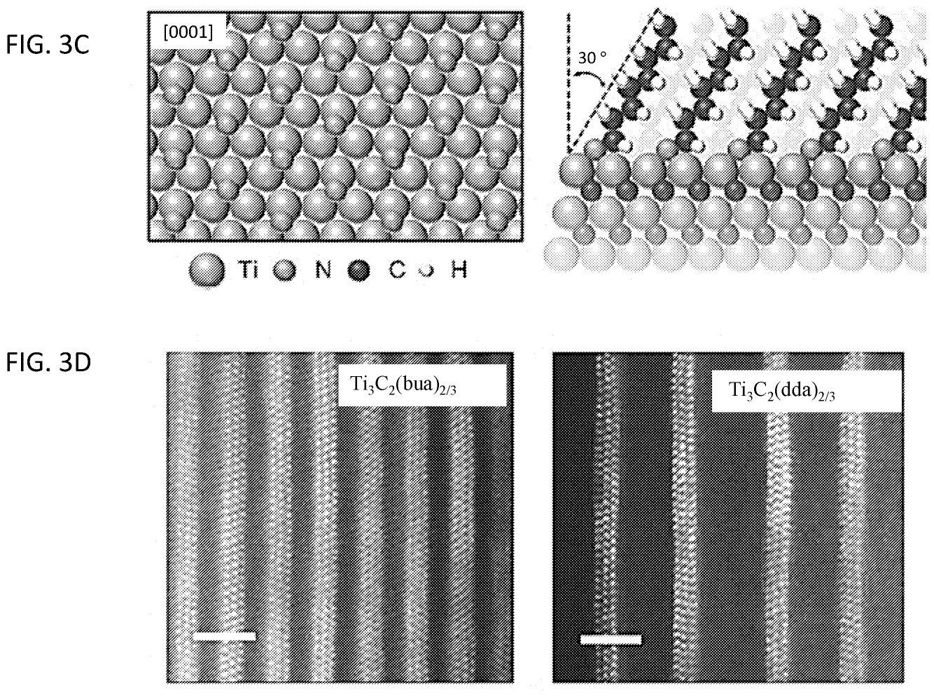

Powder X-ray diffraction (XRD) patterns for Ti₃C₂-derived h-MXenes with different n alkyl groups are shown in FIG. 3A. All structures can be assigned to the P6₃/mmc space group. The first member of this homologous series, Ti₃C₂(NH)ₓ where x˜1, can be synthesized by reacting Ti₃C₂Br₂ with NaNH₂. With an increase of the length of alkyl chain, all (0 0 0 1) diffraction peaks of h-MXenes shift to smaller 2θ angles, indicating the expansion of the spacing between Ti₃C₂ layers. Some diffraction peaks, e.g., the (0 0 0 1 0) reflection of Ti₃C₂(pra)_{2/3}, disappeared due to symmetry-related cancellation. The lattice parameters of h-MXenes, calculated using the Le Bail method, showed that the c-lattice constant linearly increased with the length of alkyl chain (FIG. 3B), which implies that the surface coverage is independent of alkyl chain length.

The α-lattice constant, which defines the distance between neighboring Ti atoms on the surface of Ti₃C₂ sheets, is practically independent of the alkyl chain length. Interestingly, the interatomic metal-metal distances at the surface of h-Ti₃C₂ MXenes (3.04 Å) are very close to those at Au (111) surface (2.88 Å), and packing of alkyl chains on these basal planes could resemble the structure of self-assembled monolayers (SAMs) of n-alkanethiol molecules on Au (111) surfaces. For the Au (111) surface, SAM grafting density is limited by the steric bulk of alkyl tails: the organic layer fills space completely with alkyl tails tilted approximately 30° from the surface normal to maximize their van der Waals interactions (FIG. 3C), whereas surface binding head groups occupy three-fold sites of a (\sqrt{3}×\sqrt{3})R30° lattice. (Dubois, L. H. et al., Annu. Rev. Phys. Chem. 43, 437-463 (1992).) Such packing produces a Ti₃C₂(NR)_{2/3} or Ti₃C₂(NHR)_{2/3} stoichiometry, which is in good agreement with the elemental analysis.

The spacing between Ti₃C₂ sheets can be compared to the length of fully extended alkyl chains. The slope of the line in FIG. 3B shows that neighboring Ti₃C₂ sheets sandwich two layers of alkyl chains with ˜1.10 Å per methylene unit. Since the theoretical length of fully extended alkyl chains with all-trans conformations is ˜1.27 Å per CH₂ group, the tilt of the alkyl chains in h-MXenes should be close to arccos (1.10 Å/1.27 Å)=30° from the surface normal, again consistent with similar packing geometries of alkyl chains in h-101 MXenes and Au (111) alkanethiol SAMs. (Bain, C. D. et al., J. Am. Chem. Soc. 111, 321-335 (1989).)

Scanning electron microscopy (SEM) and atomic-resolution scanning transmission electron microscopy (STEM) were used to directly visualize the microstructure of h-MXenes. The expansion of interlayer spacing between Ti₃C₂ sheets with the introduction of amines was clearly observed in STEM images (FIG. 3D). Electron energy loss spectroscopy (STEM-EELS) revealed the expected distribution of Ti, C, and N atoms along the c-axis of h-MXenes, and SEM-EDS mapping confirmed uniform distribution of terminating groups in macroscopic MXene stacks. To visualize organic termination groups, Ti₃C₂(tma) containing heavy sulfur atoms was imaged using atomic-resolution ABF STEM. A double-layered arrangement of tentatively 2-thiophenemethylimido groups was observed between Ti₃C₂ sheets, supporting the ordering of organic groups in h-MXenes.

Among various possible h-MXenes, those prepared from diamines, such as ethylenediamine (en) or N-methylethylenediamine (nmeda), are of particular interest as two nitrogen atoms can adopt different bonding motifs on a Ti surface. Since the observed interlayer distance in T₃C₂(en) is larger than the length of an extended en molecule, it appears the diamine ligands cannot bridge neighboring Ti₃C₂ sheets. When diamine h-MXene Ti₃C₂(nmeda) was treated with dilute hydrobromic acid, X-ray photoelectron spectroscopy (XPS) showed the formation of —NRH₃⁺ species. Meanwhile, the (0 0 0 2) peak in the XRD pattern shifted to smaller 20 angles, indicative of expansion of the interlayer distance after the protonation. Accordingly, it was concluded that in diamine h-MXenes, one nitrogen atom is bonded to the surface of Ti₃C₂ sheet while the other remains chemically accessible for protonation.

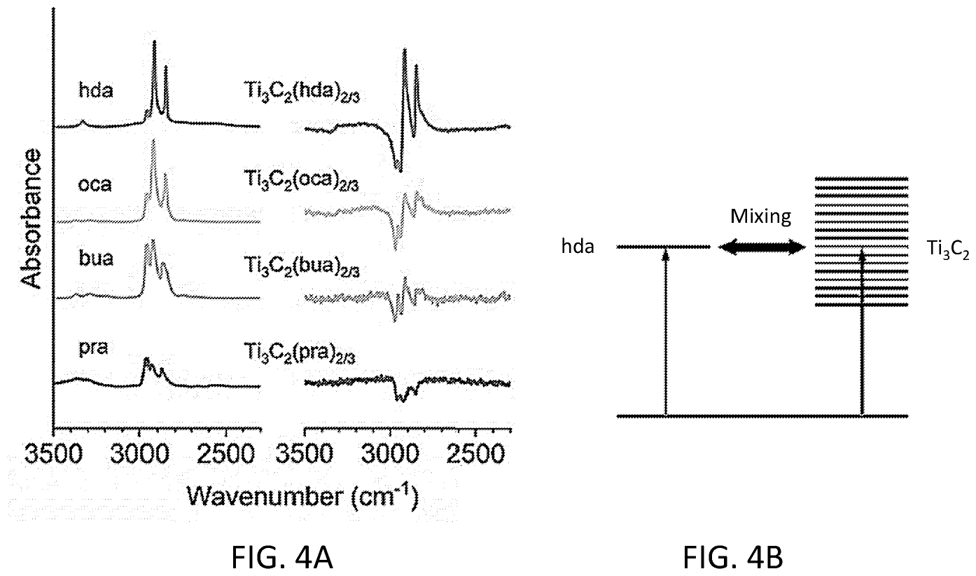

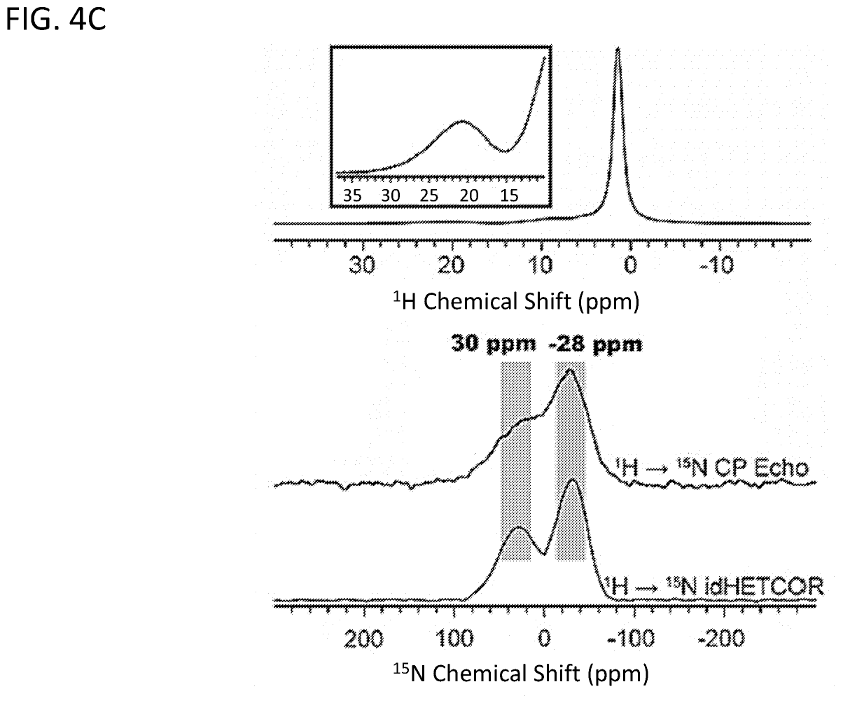

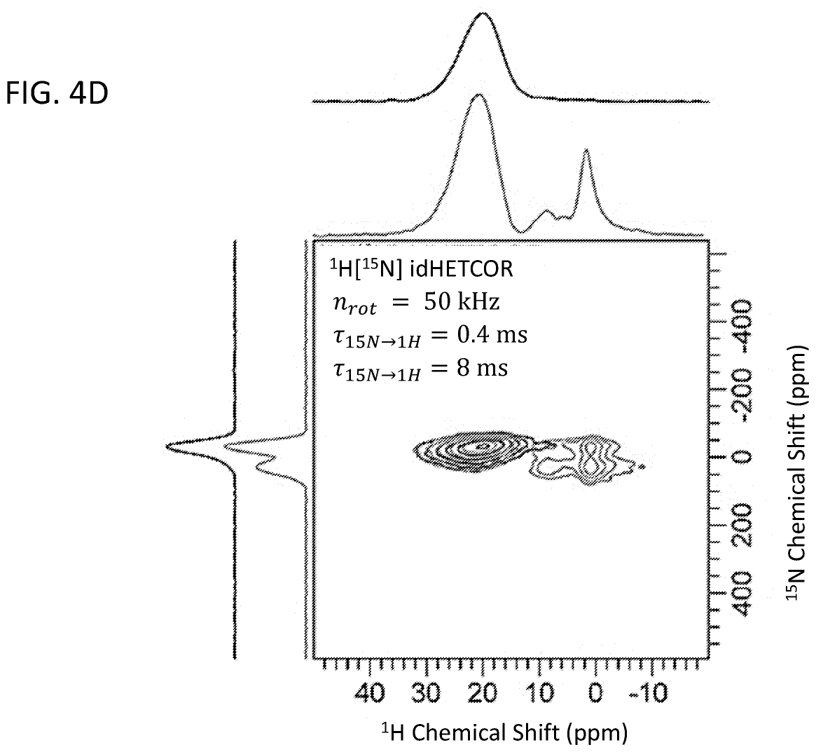

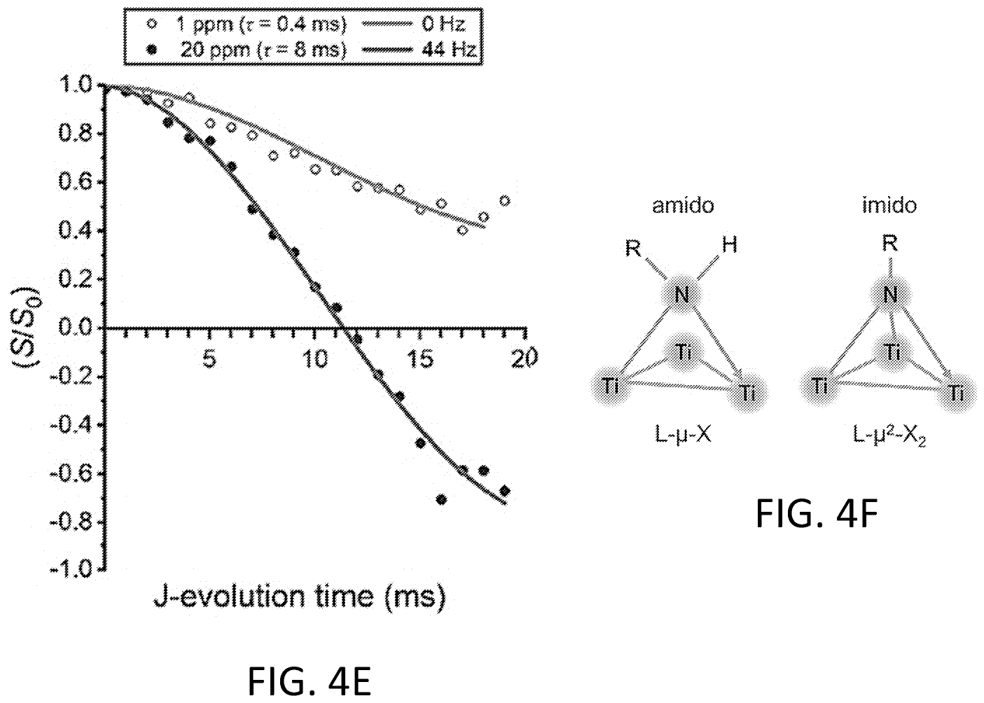

Infrared (IR) absorption spectroscopy has been routinely used to study vibrations of molecules in SAMs bound to extended metal surfaces or metal nanoparticles. Qualitatively, the vibrational spectra of surface-bound alkyl chains resemble spectra of corresponding molecules not bound to a metal surface because the molecular vibrations, e.g., C—H stretches, are practically not affected by the metal surface. A very different behavior is observed for vibrational spectra of h-MXenes: the vibronic absorption bands of n-alkylamines exhibit asymmetric line shapes characteristic of Fano resonances (FIG. 4A). Such resonances emerge when quantum states with discrete spectra, such as vibrational normal modes, coherently couple with a continuum band of states, e.g., a plasmon or polariton mode. The constructive or destructive interference of two paths (FIG. 4B) creates a characteristic asymmetric Fano line shape. In traditional SAMs on flat metal surfaces, or alkyl chains tethered to the surface of individual metal nanocrystals, this coupling of discrete and continuum states is too weak to develop the Fano effect. For h-MXenes, however, the coherent coupling of organic and inorganic components does appear to be sufficiently strong, and the inventors suggest it may originate from plasmonic enhancement of electromagnetic field between Ti₃C₂ sheets. For example, Fano resonances have been reported for molecular vibrations resonantly coupled to plasmonic hot spots with strong optical field enhancement. (Agrawal, A. et al., Nano Lett. 17, 2611-2620 (2017).) From a practical view, the coupling of organic and inorganic components of h-MXenes can be used to facilitate charge, heat, and energy transfer across the organic-inorganic interfaces.

To investigate bonding details between the organic and inorganic components of h-MXenes, magic angle spinning (MAS) solid-state NMR spectroscopy (ssNMR) was employed, which is a powerful tool for probing chemical bonding at MXene surfaces. The one-dimensional ¹H spin echo spectrum of ¹⁵N-labeled Ti₃C₂(¹⁵Ndda)_{2/3} h-MXene shows an intense peak at 1 ppm associated with overlapping CH₂ signals from dodecyl alkane hydrogens. In addition, broader and lower-intensity ¹H NMR signals centered at chemical shifts of 9 ppm and 20 ppm are visible (FIG. 4C). The latter was assigned to the NH hydrogen atoms of amido ligands, while the former was tentatively assigned to surface hydride based on a hypothesized pathway of amido to imido conversion. The ¹H→¹⁵N cross-polarized MAS (CPMAS) spin echo spectrum shows two broad ¹⁵N NMR signals with chemical shifts 30 and −28 ppm, which were assigned to imido (NR) and amido (NHR) ligands that coordinate to surface titanium atoms. These assignments are consistent with previously reported ¹⁵N chemical shifts for molecular transition metal imido and amido complexes, where the former is more positively shifted. (Beaumier, E. P. et al., Chem. Sci. 7, 2532-2536 (2016).) Peak fitting of the ¹⁵N CPMAS spin echo NMR spectrum suggests that ca. 58% of the nitrogen atoms were in the imido form, while 42% were in the amido form. The ¹⁵N signal assignments were further confirmed with ¹H{¹⁵N} indirectly detected heteronuclear correlation (idHETCOR) experiments obtained with backwards CP contact times of 0.4 ms or 8 ms to probe short- and long-range ¹H-¹⁵N internuclear distances, respectively (FIG. 4D). As expected, the HETCOR spectrum obtained with a 0.4 ms contact time only shows the amido ¹⁵N NMR signal centered at −28 ppm and reveals that it correlates to the ¹H NMR signal at +20 ppm. The HETCOR spectrum obtained with 8 ms contact time shows both imido and amido ¹⁵N NMR signals. Acquisition of 1D ¹H{¹⁵N} idHETCOR spectra with variable backwards CP contact time allowed measurement of ¹H-¹⁵N dipolar coupling constants and estimation of ¹H-¹⁵N internuclear distances. This experiment confirms that the amido hydrogen atom (δ=20 ppm) has a 1.04 Å N—H intemuclear distance and suggests that ¹H hydrogen atoms (δ=9 ppm) are ca. 1.9 Å from amido and imido nitrogen atoms. Finally, ¹H-detected ¹⁵N{¹H} heteronuclear J-resolved spin echo experiments were used to confirm that the amido nitrogen makes a covalent bond to a single hydrogen atom (FIG. 4E). The J-resolved curve obtained by monitoring the amido ¹H NMR signal can be fit with a cosine function, confirming there is only a single attached hydrogen atom. The fit yields a nitrogen-hydrogen scalar coupling constant (¹J_{NH}) of 44 Hz. A J-resolved curve for alkyl ¹H NMR signal obtained with a back-CP contact time of 8 ms can be fit with two ¹J_{NH} values of 44 Hz and 0 Hz. The latter must correspond to imido nitrogen atoms, as these nitrogen atoms do not have a covalent bond to hydrogen. Using Green's classification of covalent bonds, the amido groups can be classified as L-μ-X type ligands and the imido groups as L-μ²-X₂ type ligands (FIG. 4F). This classification has been widely used for nanocrystal surfaces and proves particularly useful in describing ligand substitution reactions.

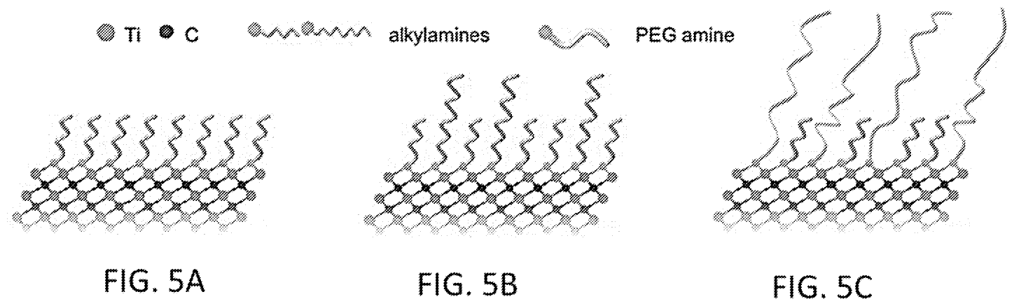

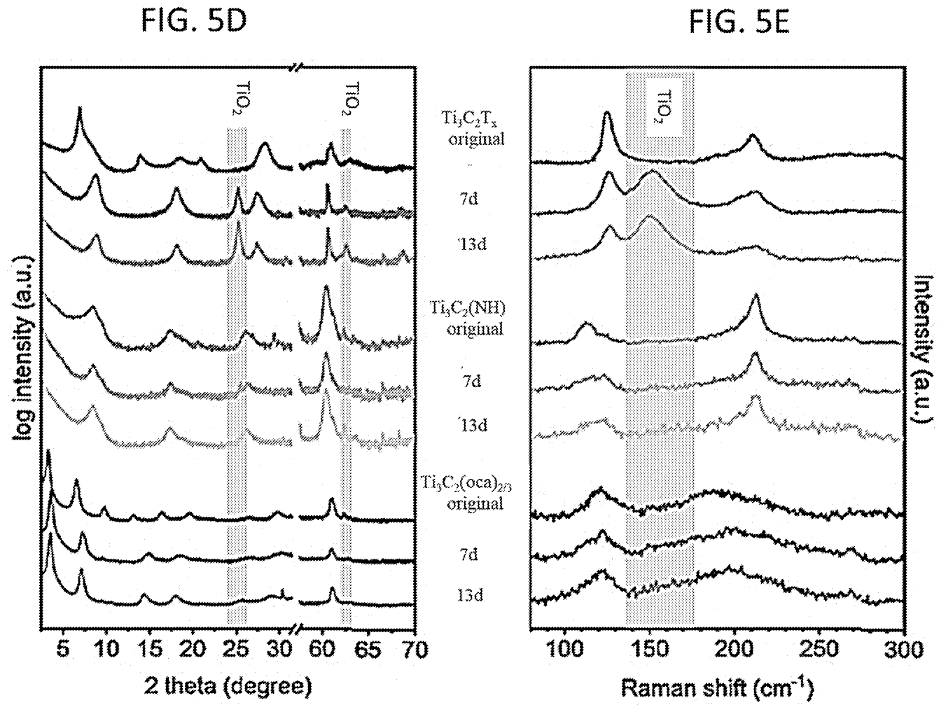

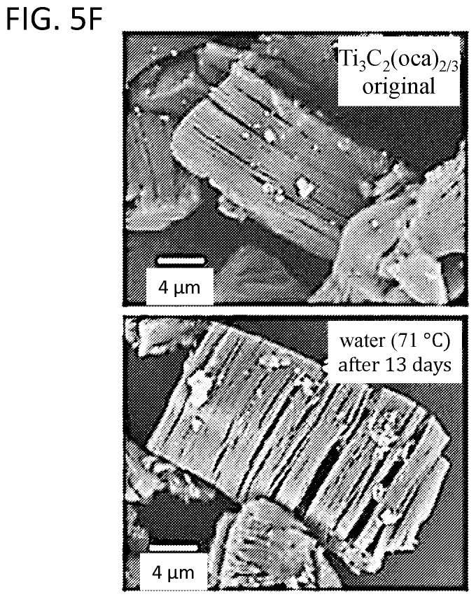

h-MXenes with an appropriate choice of surface-bound alkyl chains can be delaminated and dispersed in nonpolar solvents to form colloidal solutions (FIGS. 5A-5F). Colloidal stabilization in non-polar solvents typically requires a negative free energy of chain solvent mixing, which causes the hydrocarbon chains to repel one another, thus stabilizing colloidal dispersions. This approach works very well for small nanocrystals where surface curvature allows solvent molecules to efficiently penetrate between surface-bound alkyl chains. At the same time, chain-solvent mixing is known to be inefficient at flat surfaces with densely packed alkyl chains. Accordingly, h-MXenes with only one type of alkyl chain did not show good colloidal stability in non-polar solvents (FIG. 5A). However, simultaneous incorporation of short (e.g., octyl) and long (e.g., oleyl) chains greatly improved the colloidal stability of h-MXenes by providing room for the free rotation of long chains and efficient interaction with solvent molecules (FIG. 5B). Such combinations of organic ligands, known to the nanocrystal community as “entropic ligands”, can efficiently produce colloidal dispersions of h-MXenes in CHCl₃ with high solid concentrations (FIG. 5B). Raman spectroscopy showed that colloidal h-MXenes possess the same surface groups as their bulk counterparts. Surface exchange of Ti₃C₂Br₂ with the mixture of propylamine and PEG_{1K} amine resulted in Ti₃C₂ MXenes with PEGylated surfaces that are easily dispersed in water (FIG. 5C).

MXenes bring many exciting opportunities, but their relatively poor stability against hydrolysis, especially in basic solutions, has been a source of legitimate concerns. Different strategies have been explored to stabilize MXenes, but the effect of surface groups on the hydrolytic stability is yet to be investigated. A comparative study of the hydrolysis rates was performed for traditional Ti₃C₂Tₓ (T=F, OH, 0) MXenes with Ti₃C₂(NH) as well as Ti₃C₂(pra)_{2/3} and Ti₃C₂(oca)_{2/3} h-MXenes. To minimize the effect of sample preparation conditions, the stability of multilayer MXenes of similar size in pure water was compared at room temperature and at 71° C. A combination of XRD, XPS, and Raman spectroscopy was used to monitor sample evolution. At room temperature, Ti₃C₂Tₓ, Ti₃C₂(NH) and h-MXenes showed no obvious degradation after 35 days in air-saturated deionized (DI) water. However, in accelerated tests at 71° C., the Ti₃C₂Tₓ sample showed significant amounts of anatase TiO₂ phase formed due to hydrolysis after 7 days, while no TiO₂ phase was detected in powder-XRD patterns and in Raman spectra for Ti₃C₂(NH) and h-MXene samples (FIGS. 5D, 5E). h-MXenes also showed significantly improved stability in 0.01 M KOH solutions. The alkyl chains provide additional protection against hydrolysis by creating thin hydrophobic barriers, but since a similar stability improvement was observed for Ti₃C₂(NH), Ti₃C₂(pra)_{2/3} and Ti₃C₂(oca)_{2/3}, it is reasonable to suggest that surface Ti atoms of amido/imido-terminated MXenes are less susceptible to nucleophilic attack by hydroxyl ions, while hydrophobic surface encapsulation is a complementary and probably secondary effect. As a word of caution, Ti₃C₂(NH) and h-MXenes are not fully immune to oxidative hydrolysis in hot water. For example, XPS studies show the presence of TiO₂ at the surface of all MXene samples after one week of exposure to air-saturated water at 71° C. This was attributed to slow dissolution of titanium species from MXene edges, followed by precipitation of a thin TiO₂ layer. This layer can be only a few nanometers thick since etching of a sample surface with Ar₅₀₀⁺ clusters efficiently restores the original h-MXene surface. These studies demonstrate that amido/imido-surface chemistry generally improves MXene resistance against hydrolysis and shows that surface engineering is a viable strategy toward synthesis of functional MXenes with enhanced stability.

### Methods

Synthesis of h-MXenes.

Ti₃AlC₂ MAX phases and Cl- and Br-terminated MXenes were synthesized following a modified previously reported approach. (Kamysbayev, V. et al., 302 Science 369, 979-983 (2020).) In brief, Ti₃AlC₂ MAX phase was synthesized by mixing Ti (3.661 g), C (0.582 g) and Al (0.757 g) (3:1.9:1 molar ratio) powders and pressing into a pellet. The resulting pellet was heated in an alumina crucible at 1650° C. for 6 h under a flow of Ar. Ti₃AlC₂ (0.5 g) MAX phase was mixed with CdCl₂ or CdBr₂ salts in 1:8 molar ratio using a mortar and pestle. The resulting mixture was heated in an alumina crucible under Ar at 610° C. for at least 6 h. The Cl functionalized MXenes were recovered from the reaction mixture by dissolving excess CdCl₂ and Cd metal in concentrated aqueous HCl (12.1 M) followed by washing of the solid with deionized water until the washings had neutral pH. The Br functionalized MXenes were recovered from the reaction mixture by dissolving excess CdBr₂ and Cd metal in concentrated aqueous HBr for at least 24 h. followed by washing of the solid with deionized water until the washings had neutral pH. The resulting MXene powders were dried under vacuum at 45° C. for >12 h before further use.

Substitution reactions were all performed in an N₂-filled glovebox with oxygen and moisture levels below 0.1 ppm unless stated otherwise. The Cl- and Br-terminated MXenes act similarly during the substitution reactions. In a typical reaction procedure, Ti₃C₂Br₂ MXene (40 mg) was stirred in a mixture of amine and NaH (24 mg) or 200 μL 2.5M n-BuLi or 84 mg LiN(Si(CH₃)₃)₂ at 120° C. for 2 days in a pressurized glass vessel. Safety Precaution: NaH, n-BuLi, and LiN(Si(CH3)3)2 required special care as they can vigorously react with water. Heavy-walled glassware of an appropriate thickness should be used, since the amine may be above its boiling point, e.g., propylamine (pra, b.p. 47.8° C.), and H₂ gas is evolved. Alternatively, amine can be deprotonated by NaNH₂ at 120° C. for 1 day using a nitrogen Schlenk line. h-MXenes can be obtained by the addition of Ti₃C₂Br₂ and react at 120° C. for another 2 days under nitrogen. As prepared h-MXenes were washed with toluene and methanol to remove excessive amine, amide, and alkali halide byproduct. Powder XRD patterns and XRF spectra indicate that amines without deprotonating agents do not react with Ti₃C₂Br₂, and NaH itself also does not react with Ti₃C₂Br₂ in heptane at 120° C.

Delamination of h-MXenes.

A mixture of two amines (e.g., pra/ola, pra/PEG₁ₖ, oca/ola, with the molar ratio at 9:1 for the short and long chains, respectively) can be deprotonated by n-BuLi and then reacted with bulk Ti₃C₂Br₂ at 120° C. for 2 days to prepare delaminated h-MXenes. Oleyl chains are particularly good at disrupting packing of saturated alkyl chains and stabilizing colloidal dispersions. The as-obtained h-MXenes were washed with anhydrous toluene and methanol then stirred in CHCl₃ or NMF at 70° C. overnight for redispersion. Alternatively, Ti₃C₂Cl₂ was first delaminated following a modified previously reported method. (Kamysbayev, V. et al., 302 Science 369, 979-983 (2020).) In brief, 500 mg Ti₃C₂Cl₂ was immersed in 5 mL of 2.5 M n-BuLi solution in a sealed vial. Then, the mixture was stirred at room temperature for 24 h followed by washing with hexane and THF inside N₂ filled glovebox. 100 mg of intercalated powder and 10 mL anhydrous NMF were then added in a centrifuge tube, which was sealed while still inside the N₂ filled glovebox. After bath sonication (<10° C. to avoid possible oxidation) for 1 h, the supernatant was collected after centrifuging at 352 g force for 20 min. Finally, the supernatant was centrifuged at 12600 g force for 15 min to precipitate the MXenes, leaving small impurities in solution. The surfaces of as-obtained delaminated Ti₃C₂Cl₂ were then modified following the above method for the synthesis of organic-inorganic hybrid MXenes. The obtained product can easily redisperse in chloroform to form a stable colloid. The as-obtained h-MXenes were washed with anhydrous toluene and methanol, and then stirred in a mixture of CHCl₃ and oleylamine at 70° C. overnight for redispersion.

### Material Characterization.

Powder XRD patterns were obtained using a MiniFlex Benchtop X-ray Diffractometer from Rigaku Americas Corporation with Cu Ka X-ray source (1.5418 A) operating at 40 kV and 15 mA. XRF analysis was performed with a benchtop Energy Dispersive Rigaku NEX DE VS X-ray fluorimeter equipped with a Peltier cooled FAST SDD Silicon Drift Detector. SEM imaging and EDX elemental mapping were performed in a Carl Zeiss Merlin Field-Emission Scanning Electron Microscope equipped with Oxford Ultim Max 100 Silicon Drift Detectors (SDD). Atomic force microscopy (AFM) images were acquired using a Bruker Multimode 8 instrument equipped with a Nanoscope 5 controller. STEM imaging was performed in an aberration-corrected STEM JEOL ARM200CF at the University of Illinois at Chicago, equipped with a cold field emission gun operated at 200 kV, a Gatan Continuum electron energy-loss spectrometer (EELS) and an Oxford XMAX100TLE X-ray detector, providing a sub-Å probe-size and 350 meV energy resolution. Solid state NMR experiments were performed on a 9.4 T (v₀(¹H)=400 MHz) Bruker wide-bore NMR magnet equipped with a Bruker Avance III HD console. Experiments were performed with a Bruker 1.3 mm HX probe in double resonance mode. Raman spectra were obtained with a Horiba LabRamHR Evolution confocal microscope. XPS analysis was performed on a Kratos Axis Nova spectrometer using monochromatic Al Ka source. Raman and XPS measurements are consistent with the bonding motifs revealed by ssNMR, supporting our description of h-MXenes as a combination of amido- and imido groups bonded to Ti₃C₂ sheets.

### Extended Data:

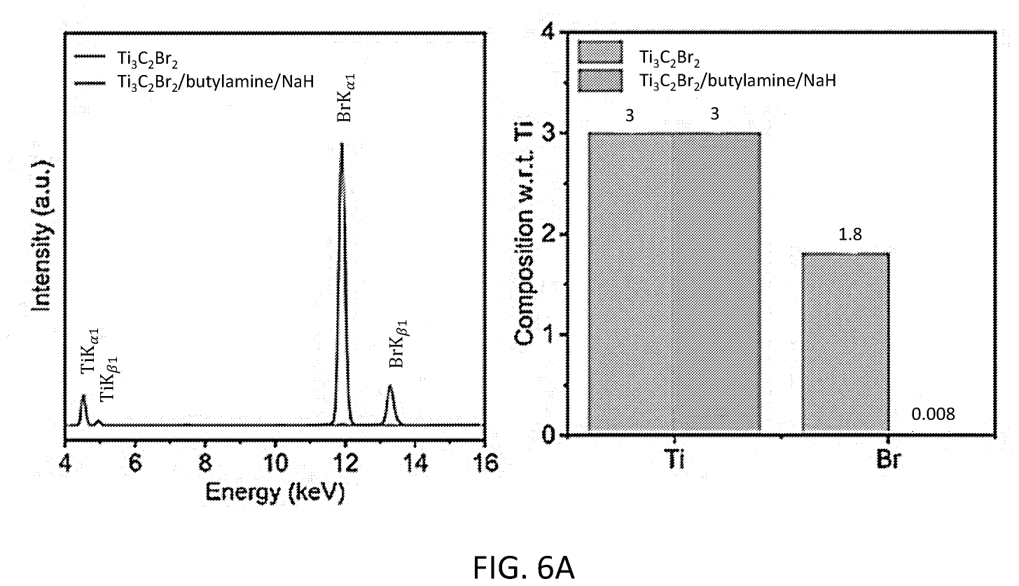

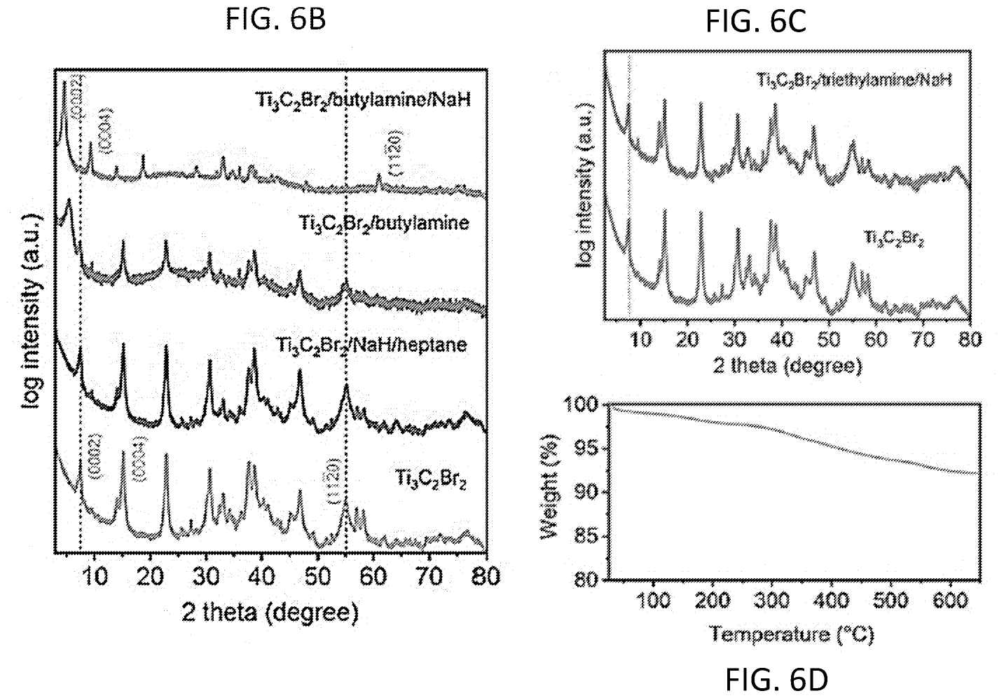

FIGS. 6A-6D show a surface exchange reaction of Ti₃C₂ MXenes with amines and thermal degradation analysis of h-MXenes. FIG. 6A shows X-ray fluorescence (XRF) spectral and elemental analysis for the Ti₃C₂Br₂ and Ti₃C₂(bua)_{2/3} MXenes. XRF spectra were normalized according to Ti K_{α1}. Based on XRF analysis, Br was completely removed after the surface modification with deprotonated butylamine. FIG. 6B shows Powder XRD patterns of products after treatment of Ti₃C₂Br₂ with butylamine and NaH at 120° C. for 2 days, as well as the products of control experiments. It was observed that Ti₃C₂Br₂ barely reacted with NaH in an inert solvent at 120° C. When treated only with butylamine at 120° C., Ti₃C₂Br₂ was seen to be partially converted or intercalated, as a new peak at 5.4° had emerged, but the majority of Ti₃C₂Br₂ was still intact. When butylamine was deprotonated by NaH and then reacted with Ti₃C₂Br₂, the (0 0 0 2) peak shifted to 4.65° while the (1 1 2̅ 0) peak shifted to 60.9°. The absence of diffraction peaks from Ti₃C₂Br₂ suggests the reaction was complete, which was confirmed by XRF analysis. FIG. 6C shows Powder XRD patterns of Ti₃C₂Br₂ before and after treatment with triethylamine and NaH at 120° C. for 2 days: The XRD pattern was unchanged, which indicates that no reaction occurred and suggests that deprotonation of amines is crucial to promoting the exchange reaction on MXene surfaces. FIG. 6D shows TGA characterization of Ti₃C₂(pra)_{2/3} MXene. The sample was heated from room temperature (around 25° C.) to 650° C. at a rate of 2° C. min⁻¹ under flowing nitrogen.

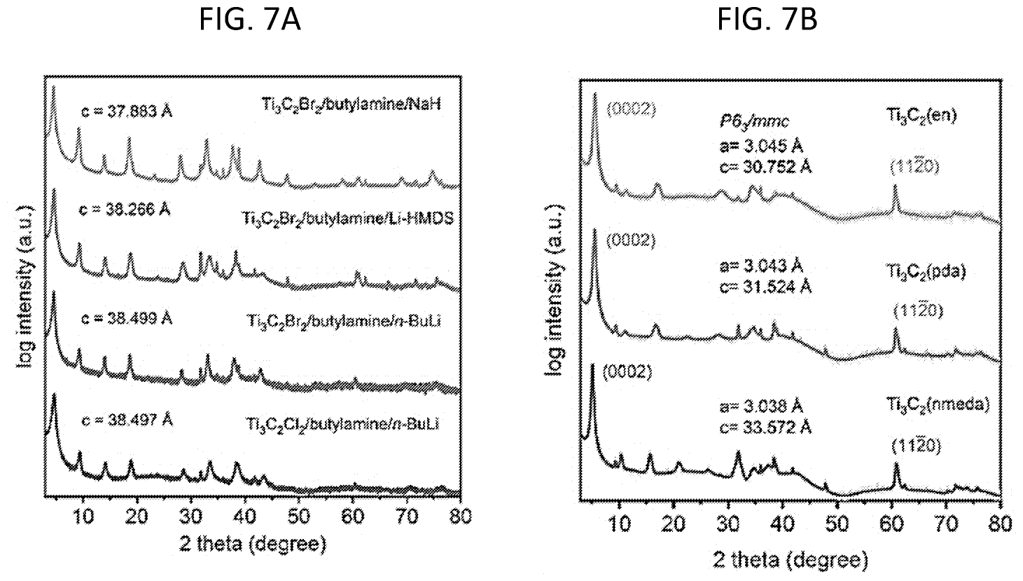

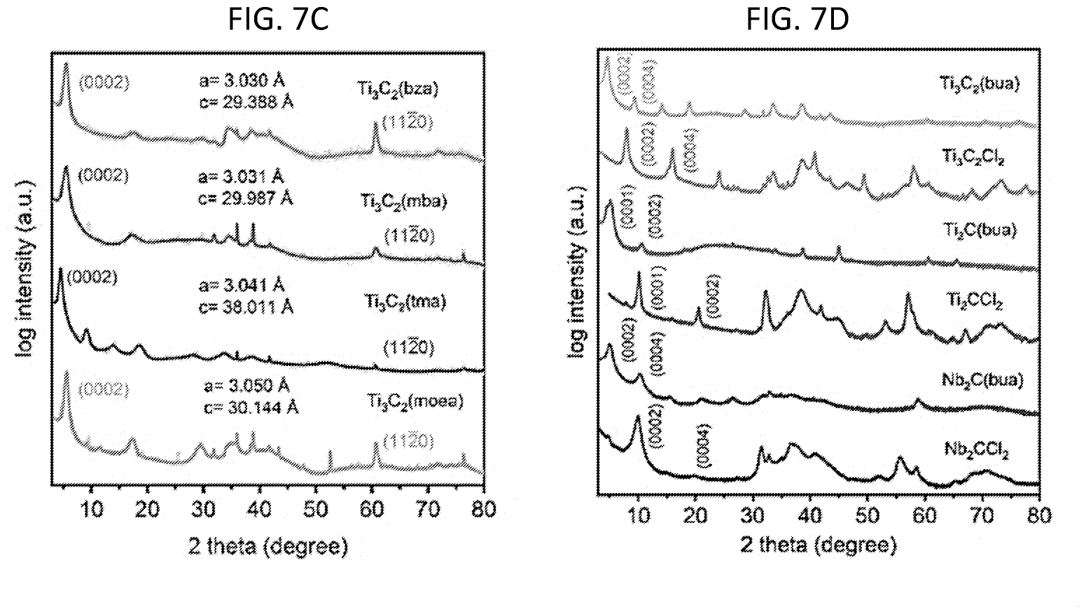

FIGS. 7A-7D show a surface exchange reaction of Ti₃C₂ MXenes with amines and thermal degradation analysis of h-MXenes. FIG. 7A shows powder XRD patterns of Ti₃C₂(bua) prepared by using different halogen terminated MXenes and deprotonating agents. Identical products were obtained using different combinations of starting halogen-terminated MXenes and deprotonating agents. FIG. 7B shows powder XRD patterns from diamine-modified h-MXenes and their Le Bail fits. FIG. 7C shows powder XRD patterns from aromatic amine- and 2-methoxyethylamine-modified h-MXenes and their Le Bail fits. FIG. 7D shows powder XRD patterns from different types of Cl-terminated MXenes treated with butylamine and n-BuLi. PXRD patterns suggest that the approach of surface modification can also be applied to other MXenes, e.g., Ti₂C and Nb₂C MXenes.

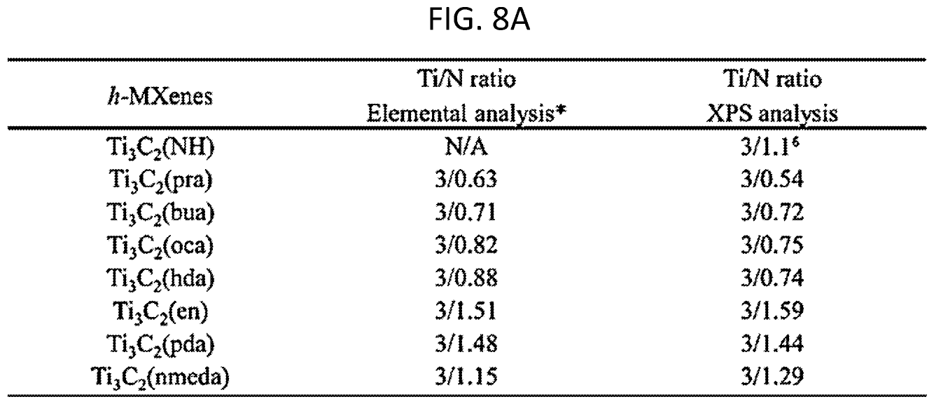

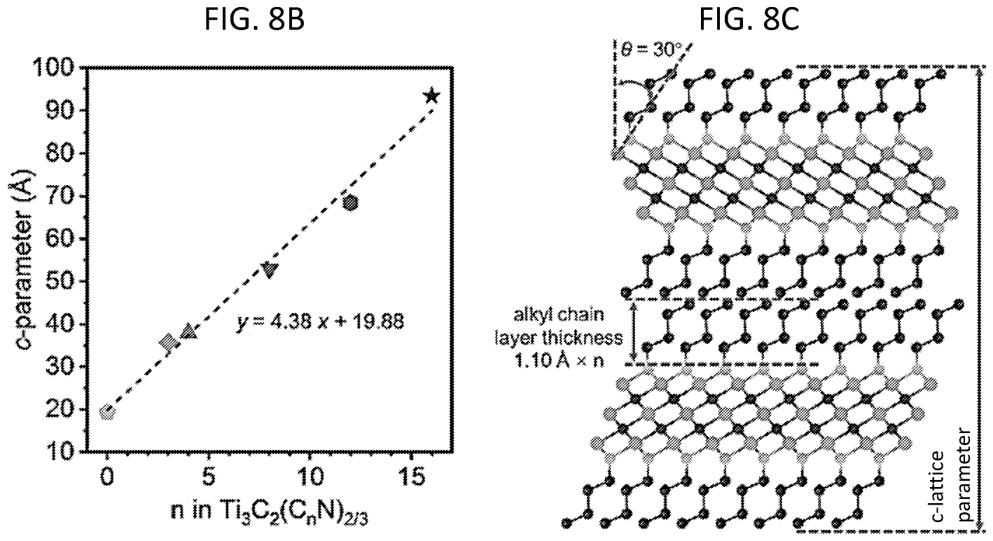

FIGS. 8A-8C show tilt angle of the alkyl chains of the surface termination groups relative to the surface normal. FIG. 8A shows a summary of the metal to surface group elemental ratios for Ti₃C₂(NH), alkylamine- and diamine-modified h-MXenes. Elemental analysis was performed on C, H, and N; the Ti/N ratio was estimated by attributing the rest of the mass to Ti. It was anticipated that the actual Ti/N ratio would be lower if any impurities existed. FIG. 8B shows change of c lattice parameters versus number of CH₂ groups in the alkylamine molecules. FIG. 8C shows a schematic of Ti₃C₂ sheets sandwiched by two layers of alkylimido surface termination groups. Each crystal unit cell contains two layers of Ti₃C₂ sheets and four layers of surface termination groups. If Ti₃C₂(NH) is used as the reference to account for contributions from Ti—N bonds and the van der Waals gaps, then the slope of FIG. 3B, i.e. 4.38 Å per CH₂ in the alkyl chain, corresponds to four times the thickness of a single alkyl monolayer. Therefore, each CH₂ unit appears to increase the thickness of the alkyl chain layer by ˜1.10 Å. As the theoretical length of a fully extended alkyl chain with all-trans conformations is ˜1.27 Å per CH₂ group, the tilt angle θ of organic surface group can be calculated to be arccos(1.10 Å/1.27 Å)−30°.

### Supplementary Information

### Supplementary Materials and Methods

### Chemicals

The following chemicals were used without further purification: Al powder (99.5%, 325 mesh), graphite (C, natural, 99.8%, 325 mesh), and Ti powder (99.5%, 325 mesh) were purchased from Alfa Aesar; Nb₂AlC (200 mesh) was purchased from Forsman Scientific; cadmium chloride (CdCl₂, 99+%, anhydrous) and cadmium bromide (CdBr₂, 99%, anhydrous) were from Strem Chemicals; hydrochloric acid (HCl, 36.5-38%) and ethylenediamine (anhydrous) were from Fisher Scientific; hydrobromic acid (HBr, 48%), toluene (99.8%, anhydrous), acetonitrile (MeCN, 99.8%, anhydrous), methanol (MeOH, 99.8%, anhydrous), chloroform (CHCl₃, 2′99%, anhydrous), n-butyllithium (n-BuLi, 2.5 M in hexanes), hexane (95%, anhydrous), tetrahydrofuran, (THF, 99.9%, anhydrous), sodium hydride (NaH, dry, 90%), lithium bis(trimethylsilyl)amide (LiN(Si(CH3)3)2, 97%), and hydrofluoric acid (HF, 48%, Sigma) were from Sigma-Aldrich; sodium amide (NaNH₂, 99%) was from Acros Organics; and phosphate buffered saline (PBS, 10×, pH 7.4) was from Thermo Scientific.

The following chemicals were dried under vacuum before handling in a glovebox. Hexadecylamine (90%) and oleylamine (70%) were obtained from Sigma-Aldrich; methoxypolyethylene glycol amine (M.W. 1,000) was obtained from Fisher Scientific; dodecylamine (¹⁵N, 98%+) was obtained from Cambridge Isotope Laboratories, Inc.

The following chemicals were purified by distillation and stored inside an inert atmosphere glovebox: N-methyl formamide (NMF, 99%), propylamine (2′99%), butylamine (99.5%), octylamine (99%), dodecylamine (98%), benzylamine (99%), α-methylbenzylamine (99%), 2-thiophenemethylamine (96%), triethylamine (2′99.5%), 2-methoxyethylamine (99%), and 2-(2-methoxyethoxy)ethanamine (2′95%) were purchased from Sigma-Aldrich; N-methylethylenediamine (97.0+%) and 1,3-diaminopropane (98.0+%) were purchased from TCI America.

### Synthesis of Ti₃AlC₂ MAX Phase

Ti₃AlC₂ MAX phase was synthesized following a modified previously reported approach. (Kamysbayev, V. et al., Science 369, 979-983 (2020).) In brief, Ti (3.661 g), C (0.582 g) and Al (0.757 g) (3:1.9:1 molar ratio) powders were mixed and pressed into a pellet. The resulting pellet was heated in an alumina crucible at 1650° C. for 6 h under a flow of Ar.

### Synthesis of Cl- and Br-Terminated Terminated MXenes

Ti₃AlC₂(0.5 g) MAX phase was mixed with CdCl₂ or CdBr₂ salts in 1:8 molar ratio using a mortar and pestle. The resulting mixture was heated in an alumina crucible under Ar at 610° C. for at least 6 h. For Cl-terminated Nb₂C MXenes, Nb₂AlC MAX phase (0.578 g) was mixed with CdCl₂ salt in 1:10 molar ratio using a mortar and pestle. The resulting mixture washeated in an alumina crucible under Ar at 710° C. for 36 h. The Cl functionalized MXenes were recovered from the reaction mixture by dissolving excess CdCl₂ and Cd metal in concentrated aqueous HCl (12.1 M) followed by washing of the solid with deionized water until the washings had neutral pH. The Br functionalized MXenes were recovered from the reaction mixture by dissolving excess CdBr₂ and Cd metal in concentrated aqueous HBr for at least 24 h, followed by washing of the solid with deionized water until the washings had neutral pH. The resulting MXene powders were dried under vacuum at 45° C. for >12 h before further use.

### Synthesis of Organic-Inorganic Hybrid MXenes

Substitution reactions were all performed in an N₂-filled glovebox with oxygen and moisture levels below 0.1 ppm unless stated otherwise. The Cl- and Br-terminated MXenes act similarly during the substitution reactions. In a typical reaction procedure, Ti₃C₂Br₂ MXene (40 mg) was stirred in a mixture of amine and 24 mg NaH (alternative deprotonating agents are 200 μL 2.5 M n-BuLi in hexane or 84 mg LiN(Si(CH3)3)2) at 120° C. for 2 days in a sealed glass vessel. (Caution: heavy-walled glassware of an appropriate thickness should be used since the amine may be above its boiling point and H₂ gas is evolved.) Alternatively, organic amine can be deprotonated by NaNH₂ at 120° C. for 1 day using a nitrogen Schlenk line. The reaction is promoted by the removal of volatile NH₃ product. h-MXenes can be obtained by the addition of Ti₃C₂Br₂ and react at 120° C. for another 2 days under nitrogen. For Ti₃C₂Cl₂, a slightly higher temperature is required, considering the higher dissociation energy of Ti—Cl bonds compared to Ti—Br bonds. All products were recovered by washing with anhydrous toluene and anhydrous MeOH inside an N₂-filled glovebox in order to avoid possible oxidation of the surface groups.

### Synthesis of Delaminated Organic-Inorganic Hybrid MXenes

A mixture of two n-alkylamines (with the molar ratio at 9:1 for the short and long alkyl chains, respectively) can be deprotonated by n-BuLi and then reacted with bulk Ti₃C₂Br₂ at 120° C. for 2 days to prepare delaminated h-MXenes. The as-obtained h-MXenes were washed with anhydrous toluene and methanol, and then stirred in CHCl₃ or NMF at 70° C. overnight for redispersion. Similarly, oleylamine or PEG₁ₖ amine can be used as long-chain amines in combination with a short alkylamine.

Alternatively, Ti₃C₂Cl₂ was delaminated following a modified previously reported method. (Kamysbayev, V. et al., 2020.) In brief, 500 mg Ti₃C₂Cl₂ was immersed in 5 mL of 2.5 M n-BuLi solution in a sealed vial. Then, the mixture was stirred at room temperature for 24 h followed by washing with hexane and THF inside N₂ filled glovebox. 100 mg of intercalated powder and 10 mL anhydrous NMF were then added in a centrifuge tube, which was sealed while still inside the N₂ filled glovebox. After bath sonication (<10° C. to avoid possible oxidation) for 1 h, the supernatant was collected after centrifuging at 352 g force for 20 min. Finally, the supernatant was centrifuged at 12600 g force for 15 min to precipitate the MXenes, leaving small impurities in solution. The surfaces of delaminated Ti₃C₂Cl₂ were modified following the above method for the synthesis of organic-inorganic hybrid MXenes. The as-obtained delaminated hybrid MXenes were stirred in a mixture of CHCl₃ and oleylamine at 70° C. overnight; after centrifugation at 12600 g force, the precipitate was redispersed in CHCl₃ to form a colloidal solution.

### X-Ray Diffraction (XRD)

The diffraction patterns in reflection mode were obtained using a benchtop powder X-ray diffraction instrument using Cu Ka X-ray source (1.5418 A) operating at 40 kV and 15 mA. XRD full pattern Le Bail fits were performed using TOPAS Version 5 software. The MXene phase sample was assigned to P6₃lmmc space group for the purpose of refinement. Since the intensity of elastic X-ray scattering is dominated by the heavy atoms, Ti in our case, this structure assignment is useful for La Bail refinement to extract the unit cell parameters, even if it does not capture the full symmetry of MXene surface groups. The Stephens model (hexagonal symmetry) was used to account for the anisotropic peak broadening of the XRD patterns of MXene phases.

### Scanning Transmission Electron Microscopy (STEM) Characterization

Atomic-resolution characterization of the MXene samples was conducted using the aberration-corrected scanning transmission electron microscope (STEM) JEOL ARM200CF at the University of Illinois at Chicago, equipped with a cold field emission gun operated at 200 kV, a Gatan Continuum electron energy-loss spectrometer (EELS) and an Oxford XMAX100TLE X-ray detector, providing a sub-A probe-size and 350 meV energy resolution. The emission current was reduced to 12 μA in order to reduce damage from the electron beam.

An electron probe convergence semi-angle of 24 mrad was used. Incoherent high-angle annular dark field (HAADF) imaging was conducted with inner and outer angles set to 68 mrad and 280 mrad, while low-angle annular dark field (LAADF) imaging was set up with 30 mrad and 120 mrad detector angles. Annular bright field (ABF) imaging was conducted using an outer angle of 23 mrad and an inner angle of 11 mrad.

X-ray energy dispersive spectroscopy (XEDS) measurements were performed using an Oxford XMX100TLE X-ray windowless silicon drift detector controlled by Oxford Aztec software. A post-column Gatan Continuum Imaging Filter was used for electron energy loss spectroscopy (EELS) measurements with an electron probe convergence semi-angle of 17.8 mrad and a collection angle of 53.4 mrad. Elemental composition ratios were determined using the built-in elemental analysis available in DigitalMicrograph version 3.5.

The TEM samples were prepared inside a nitrogen glovebox maintained at <1 ppm H₂O and O₂. Samples were suspended in 5 ml of methanol and then drop-cast onto a 3 mm copper lacey carbon grid. The grid was then allowed to dry for a minimum of an hour. The grids were then loaded onto a double tilt holder. In-situ cooling experiments were conducted using a Gatan 363 double-tilt liquid nitrogen holder. To decrease the amount of latent moisture, the samples were heated to 60° C. inside the microscope column for an hour prior to cooling.

Microtomed samples were infiltrated with LX-112 resin for 2 hours at room temperature and then placed in a 60° C. oven to polymerize over 2 days. Ultra-thin sections (65-70 nm) were cut using a Leica Ultracut UCT model ultramicrotome and collected onto 200-mesh copper-rhodium grids.

### Scanning Electron Microscopy-Energy Dispersive X-Ray Spectroscopy (SEM-EDX)

SEM imaging and EDX elemental mapping were performed in a Carl Zeiss Merlin Field-Emission Scanning Electron Microscope equipped with Oxford Ultim Max 100 Silicon Drift Detectors (SDD). The accelerating voltage was set to 10 kV and beam current was set to 1 nA.

### Atomic Force Microscopy (AFM)

The imaging of h-MXene was carried out using a Bruker Multimode 8 instrument equipped with a Nanoscope 5 controller. The images were acquired using ScanAsyst mode.

### Fourier-Transform Infrared Spectroscopy (FTIR)

FTIR absorption spectra were acquired using a Thermo Nicolet iS50 Advanced FTIR Spectrometer equipped with VariGATR™ grazing angle ATR accessory.

### Magic Angle Winning (MAS) Solid State NMR

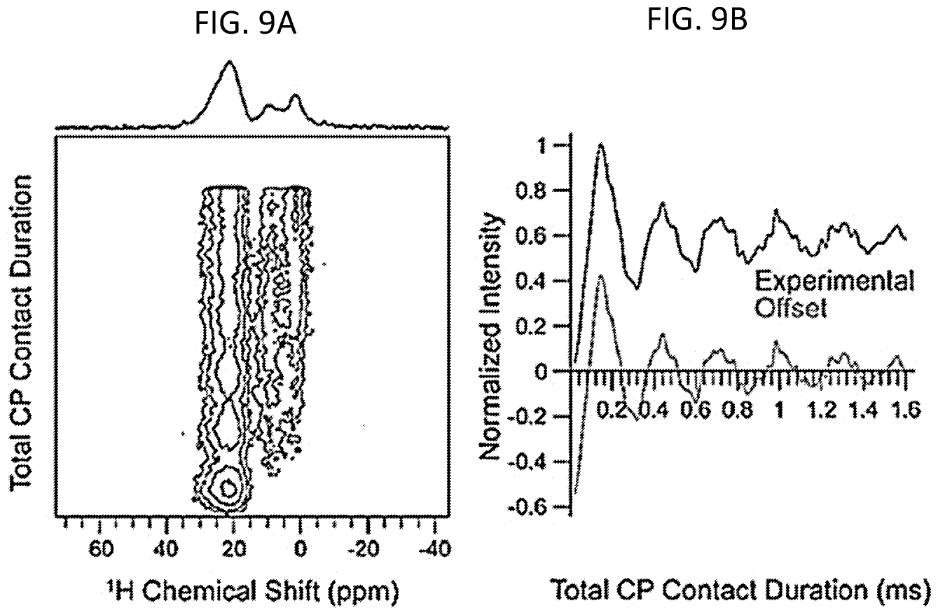

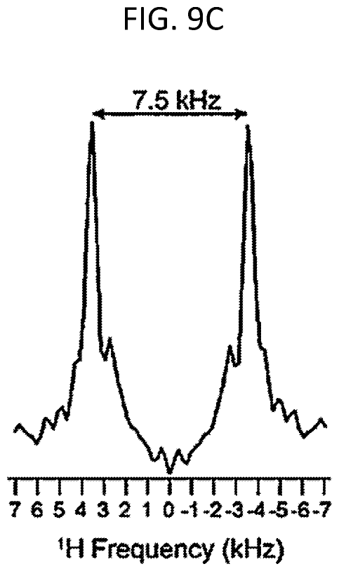

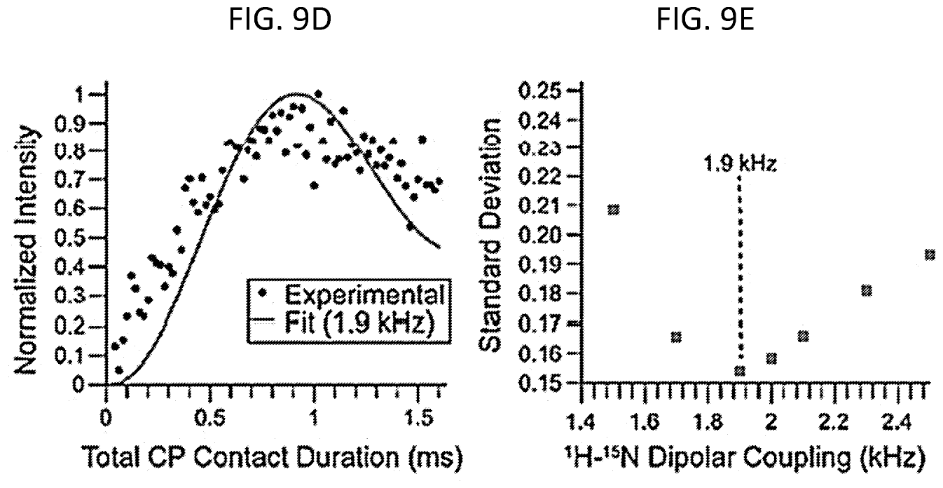

Solid state NMR experiments were performed on a 9.4 T (v₀(¹H)=400 MHz) Bruker wide-bore NMR magnet equipped with a Bruker AVANCE III HD console. Experiments were performed with a Bruker 1.3 mm HX probe in double resonance mode. All samples were packed into 1.3 mm zirconia rotors in a dry argon glovebox. N₂ gas was used to spin the rotor for MAS experiments. Before the NMR experiments were conducted, the magic angle was precisely set by minimizing the breadth of the second spinning sideband of potassium bromide. The ¹H RF powers were calibrated directly on each sample by using a nI2-spin-lock pulse sequence to determine the second-order rotary resonance recoupling condition (v₁=2xvᵣₒₜ). A 100 kHz RF field was used for all ¹H pulses. All experiments were performed at 50 kHz MAS frequency. 2D ¹H homonuclear dipolar DQ-SQ correlation NMR spectra were acquired with the BABA pulse sequences with 2 rotor-cycles for DQ excitation and reconversion. ¹H-+¹⁵N cross polarization (CP) was directly optimized on each sample. Each CP step used a ¹H spin-lock RF field which linearly ramped from ca. 130 to 145 kHz while the ¹⁵N spin-lock RF field was held at ca. 82 kHz. 1D ¹H-¹⁵N CPMAS spin echo NMR spectra were obtained with 25600 scans with an echo delay of two rotor cycles. 2D ¹H{¹⁵N} idHETCOR spectra were obtained with previously described pulse sequences. The forwards and backwards CP contact durations are indicated in FIGS. 9A-9E. The ¹H-detected ¹⁵N{¹H} J-resolved curves were obtained with 32 scans while incrementing the J-evolution time (spin echo duration) in steps of 1 ms. For each spin echo duration, a data set was obtained with and without a ¹H v-pulse to remove the effects of transverse relaxation. For the ¹⁵N{¹H} J-resolved experiments, the forward CP contact time was set to 5 ms and the back CP contact time was 0.4 ms or 8 ms. ¹H-¹⁵N dipolar coupling constants were measured with ¹H-detected variable back contact-time CP (VC-CP) experiments. In the VC-CP experiments, the forward contact duration was fixed at 5 ms while incrementing the back contact time in steps of 20 μs. For the back-CP step, the ¹H and ¹⁵N spin-lock RF fields were held constant at 132 kHz and 82 kHz. 8 scans were acquired for each step. SIMPSON numerical simulations of VC-CP using the experimentally employed RF fields indicated that the scaling factor of the dipolar coupling constant was 1.43. For the NH ¹H NMR signal, the vertically-offset variable contact time curve was vertically offset then Fourier transformed, and this yielded a 7.5 kHz dipolar splitting, which corresponds to a 10.7 kHz ¹H-¹⁵N dipolar coupling constant and 1.04 Å bond length. The VC-CP curves for other ¹H NMR signals were fit with numerical SIMPSON simulations to estimate dipolar coupling constants.

¹H longitudinal relaxation (Ti) measurements were performed on each sample using a saturation recovery experiment. All experiments were recorded with longitudinal relaxation delays (1.3×T₁=1.08 s). ¹H chemical shifts were indirectly referenced to TMSS adamantane (iso=1.70 ppm). ¹⁵N chemical shifts were indirectly referenced to a neat solution of MeNO₂ (iso=0 ppm) using the IUPAC recommended Larmor frequency ratio of 10.136767%. All spectra were processed in TopSpin 3.6.2.

### Raman Spectroscopy

Raman spectra were obtained with a Horiba LabRamHR Evolution confocal microscope. A Si(111) wafer was used for calibration. The samples were excited using a 633 nm light source operating at 2.5% power or a 785 nm light source operating at 5% power and using a 100× long working distance objective and a 600 mm⁻¹ grating. Raman spectra instability tests were collected using the microscope's mapping mode with a 50× long working distance objective.

### X-Ray Fluorescence (XRF)

XRF analysis was performed with a benchtop Energy Dispersive Rigaku NEX DE VS X-ray fluorimeter equipped with a Peltier cooled FAST SDD Silicon Drift Detector. All analyses were carried out under He atmosphere to increase sensitivity for lighter elements. Elemental ratios were determined using the standardless thin film fundamental parameters method as programmed in QuantEZ software provided by Rigaku, using the standard Rigaku calibration protocols.

For a consistent analysis, the samples were prepared by drop casting powders dispersed in anhydrous MeOH on a Si substrate of an approximate 1×1 cm square size to provide uniform thin films throughout the series. The films were loaded into the instrument and the analysis window was set at 10 mm diameter. All samples were measured and analyzed in the same manner.

### Elemental Analysis

Elemental analysis was performed by combustion using automatic analyzers by Atlantic Microlab, Inc. The amount of Ti was calculated with the assumption that Ti is the only element besides C, H, N.

### X-Ray Photoelectron Spectroscopy (XPS)

XPS analysis was performed on a Kratos Axis Nova spectrometer using a monochromatic Al Ka source (1486.6 eV). Ti 2p, N 1s, C 1s, Cl 2p, and Br 3d high-resolution spectra were collected using an analysis area of 0.3×0.7 mm² and 20 eV pass energy with the step size of 100 meV. Charge neutralization was performed using a co-axial, low energy (::0.1 eV) electron flood source to avoid shifts in the recovered binding energy. The C 1s peak of Ti—C—N was fixed during analysis at 282.0 eV to compensate for any remaining charge-induced shifts. Deconvolution of the high-resolution XPS spectra was performed in CasaXPS software with a Touguaard background following the method presented by Natu et al. (Natu, V. et al., Matter (2021).). All MXene-related peaks were fitted using an asymmetric Lorentzian line shape, while the oxide and free amine peaks were fitted using a symmetric Lorentzian-Gaussian line shape. The Ti 2p region consists of the two 2p₃₁₂ and 2p₁₁₂ spin-orbit split components. The peak area ratio of 2₃₁₂ to 2p₁₁₂ was fixed to 2 to 1. The Ti 2p region was fit using two pairs of 2p₃₁₂ and 2p₁₁₂ components for each sample. Ti atoms in the middle layer of Ti₃C₂ and C—Ti—N were indistinguishable by conventional XPS¹². The quantification of Ti:N ratio from survey XPS spectra was used to derive the stoichiometry of h-MXenes

### Example 2: Alkoxy-Terminated h-MXenes

This example illustrates methods for the synthesis of alkoxy-terminated MXenes, using Ti₃C₂(bua)_{2/3} as an illustrative examples. However, other alkoxy-terminated or aryloxy-terminated MXenes can be synthesized using the guidance provided in this example by starting with different alcohol reactants, halogen surface-terminated MXenes of different early transition metals and/or halogen surface-terminated nitride MXenes.

The Ti₃C₂(buo) was formed by reacting Ti₃C₂Br₂ with butanol in the presence of the deprotonating agent n-BuLi. The reaction was performed in an N₂-filled glovebox with oxygen and moisture levels below 0.1 ppm. In a typical reaction procedure, Ti₃C₂Br₂ MXene was stirred in a mixture of butanol and 2.5 M n-BuLi at 120° C. for 80 hours in a sealed glass vessel. All products were recovered by washing with anhydrous MeOH and anhydrous toluene inside an N₂-filled glovebox in order to avoid possible oxidation of the surface groups.

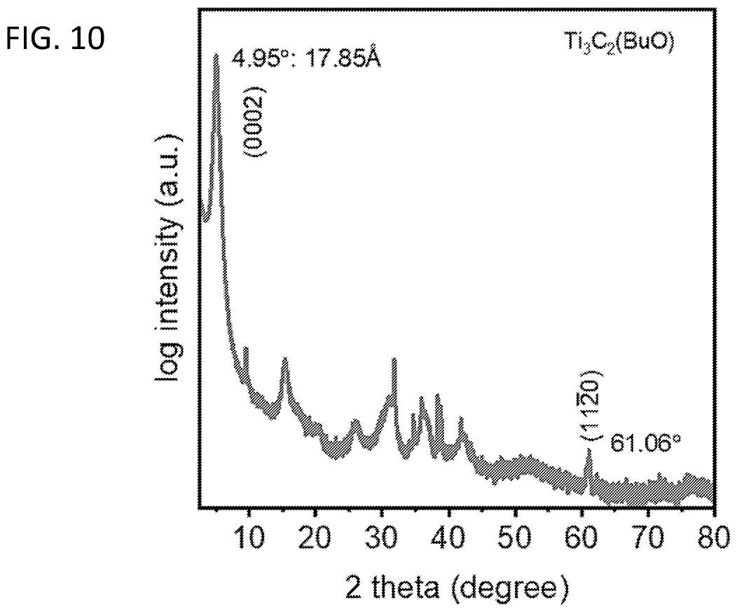

A powder XRD pattern for Ti₃C₂(buo)_{2/3} is shown in FIG. 10. The peak at (1 1 2̅ 0) is consistent with a surface terminating oxygen atom of an alkoxy group, while the (0 0 0 2) peak indicates an interplanar distance comparable with that of Ti₃C₂(bua)_{2/3} (butylamido/imido terminated MXenes).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A hybrid organic-inorganic two-dimensional transition metal carbide or nitride MXene having the formula: M₍ₙ₊₁₎Xₙ(NR)ₓ(NHR)_{y}, where 1≤n≤4, M is an early transition metal atom, X is carbon or nitrogen, NR represents surface-terminating amido groups, and NHR represents surface-terminating imido groups, where R is an organic functional group, at least one of x and y is greater than zero, and (x+y)≤1; or M₍ₙ₊₁₎Xₙ(OR′)_{z}, where 1≤n≤4, M is an early transition metal atom, X is carbon or nitrogen, OR′ represents surface-terminating alkoxy or aryloxy groups, and 0<z≤1.

2. The MXene claim 1, wherein X is carbon.

3. The MXene of claim 1, wherein M is titanium.

4. The MXene of claim 1, having the formula M₍ₙ₊₁₎Xₙ(NR)ₓ(NHR)_{y}.

5. The MXene of claim 4, wherein the organic functional groups are independently selected from alkyl groups, alkenyl groups, alkynyl groups, alkylamine groups, alkylaryl groups, ether groups, and combinations of two or more thereof.

6. The MXene of claim 5, wherein the organic functional groups comprise the alkyl groups.

7. The MXene of claim 6, wherein the organic functional groups are propyl groups, butyl groups, octyl groups, dodecyl groups, hexadecyl groups, or a combination thereof.

8. The MXene of claim 5, wherein the organic functional groups comprise the alkylamine groups.

9. The MXene of claim 8, wherein the organic functional groups are aminoethyl groups, aminopropyl groups, N-methylethylamine groups, or a combination thereof.

10. The MXene of claim 5, wherein the organic functional groups comprise the alkylaryl groups.

11. The MXene of claim 10, wherein the organic functional groups are benzyl groups, methylbenzyl groups, thiophenylmethyl groups, or a combination thereof.

12. The MXene of claim 5, wherein the organic functional groups comprise the ether groups.

13. The MXene of claim 12, wherein the organic functional groups are 2-methoxyethyl groups, 2-(2-methoxyethoxy)ethyl groups, poly(ethylene glycol) groups, or a combination thereof.

14. The MXene of claim 5, wherein X is carbon.

15. The MXene of claim 14, wherein M is titanium.

16. The MXene of claim 1, having the formula M₍ₙ₊₁₎Xₙ(OR′)_{z}.

17. The MXene of claim 16, wherein OR′ is an alkoxy group.

18. A method for the synthesis of the hybrid organic-inorganic two-dimensional transition metal carbide or nitride MXene of claim 1, the method comprising: reacting a primary organic amine or an alcohol with a two-dimensional transition metal carbide or nitride MXene having the formula M₍ₙ₊₁₎XₙTₓ, where T represent surface-terminating halogen atoms and 0<x≤2, in the presence of a deprotonating agent, whereby the surface-terminating halogen atoms are displaced by deprotonated primary organic amines or alcohols.

19. The method of claim 18, wherein X is carbon.

20. The method of claim 18, wherein M is titanium.

21. The method of claim 18, wherein the surface-terminating halogen atoms are chlorine atoms, bromine atoms, or a combination thereof.

22. The method of claim 18, wherein the primary organic amines comprise alkylamines, organic diamines, alkylarylamines, polyalkylene glycol amines, or combinations of two or more thereof.

23. The method of claim 18, wherein the deprotonating agent comprises a sodium-containing or lithium-containing base.

24. The method of claim 23, wherein the deprotonating agent comprises NaH, NaNH₂, an alkyllithium compound, lithium-bis(trimethylsilyl)amide, or a combination of two or more thereof.
